(19) United States
(12) Patent Application Publication
(10) Pub. No.: US 2006/0149671 A1
(43) Pub. Date: Jul. 6, 2006

(54) Payment processing method and system

(76) Inventors: Robert Nix, Concord, MA (US); Alek Mesarovich, Brookline, MA (US); Theodore Schwartz, Stow, MA (US); Jeffrey Schachter, Littleton, MA (US); Peter Masters, Arlington, MA (US); Jason Mondanaro, Chelmsford, MA (US); Ronald Rivest, Arlington, MA (US); Silvio Micali, Brookline, MA (US); Prasad Jonnalagadda, Acton, MA (US)

Correspondence Address: MCDERMOTT WILL & EMERY LLP;ATTN: INTELLECTUAL PROPERTY DEPTARTMENT, 28 STATE STREET, BOSTON, MA, 02109, US

(21) Appl. No.: 11/169,075

(22) Filed: Jun. 27, 2005

Related U.S. Application Data
(60) Provisional application No. 60/583,010, filed on Jun. 25, 2004.
(60) Provisional application No. 60/648,789, filed on Feb. 1, 2005.

(51) Int. Cl. G06Q 40/00

(52) U.S. Cl. 705/40

(57) ABSTRACT

A payment processing system includes one transaction processor that aggregates cost data associated with low-priced sales transactions between a consumer and a merchant. The transaction processor sends data that represents the aggregated cost data to an acquiring banking entity associated with the merchant. The system also includes another transaction processor that stores data that represents each individual low-priced sales transaction. The stored data is accessible by one or more banking entities associated with the merchant.

### RELATED APPLICATIONS

This application claims the benefit of priority to: (a) U.S. Provisional Application No. 60/583,010, filed Jun. 25, 2004, entitled “Small Payment Gateway Method and System”; (b) U.S. Provisional Application No. 60/648,789, filed Feb. 1, 2005, entitled “Edge Process for Small Transaction Method and System”.

### TECHNICAL FIELD

This disclosure relates to processing payments and, more particularly, to processing low-priced purchases to reduce transaction costs.

### BACKGROUND

With the introduction of credit and debit cards and their ever-increasing use in the marketplace, industry trends show that these instruments are becoming the preference of more and more consumers. In 2003, for the first time, consumers made more payments using electronic payment methods than using cash or check-based payment methods. Surveys find that more than 37 million Americans have made point-of-sale (POS) purchases with a card for $5 or less, and the number of Americans buying online content with a card has grown from 4 million to 14 million in less than a year. Additionally, contact-less payment cards based on radio frequency identification (RFID) technology are under deployment and may accelerate these consumer trends.

The volume of small payments in the physical POS, digital, and mobile markets is escalating at a staggering pace. There are more than $1.3 trillion in cash payments under $5 in the US; digital payments exceed $3 billion with >20% compound annual growth rate (CAGR); mobile payments exceed $0.5 billion with >100% CAGR; and the world-wide opportunity is even larger.

While there is substantial merchant interest in small payment business models, potential problems may hinder the production of a profitable business based on small payments. For example, high transaction processing costs may have a negative impact on business profitability. Typical transaction processing costs may be $0.25+2% of the transaction. For a low-priced transaction of $1 the transaction processing cost is $0.27, or 27% of the transaction. This is a substantial transaction cost for supporting a profitable business for a merchant. Some financial industry sources report that overall handling costs for transactions are $0.20 to $0.40, and that the industry loses money on transactions below $10.

Along with transaction costs, customer support costs may have a substantial impact on revenue and profits. Conventional customer service costs are typically $5 to $10 per incident for telephone support, and $15 to $30 per incident for payment-related support that results in a chargeback. Providing high-quality customer support is a critical part of developing and growing a business, however, high customer support costs may reduce profitability.

Customer acquisition costs may not correlate with the value of a lifetime customer. Merchants may incur significant marketing expenses to attract and retain customers. For example, costs may range from $2 to $4 in advertising per customer for quick-serve restaurants to $20 to $40 per customer for Internet businesses. To combat these issues merchants are interested in flexible and cost-effective ways to establish frequent consumer purchases. For example, merchants may produce compelling new products and services, implement no-hassle policies, establish integrated loyalty and rewards programs, or initiate targeted promotions (sometimes with third party partners).

### SUMMARY OF THE DISCLOSURE

In accordance with an aspect of the disclosure, a payment processing system includes one transaction processor that aggregates cost data associated with low-priced sales transactions between a consumer and a merchant. The transaction processor sends data that represents the aggregated cost data to an acquiring banking entity associated with the merchant. The system also includes another transaction processor that stores data that represents each individual low-priced sales transaction. The stored data is accessible by one or more banking entities associated with the merchant.

In one embodiment, the second transaction processor may be located remote from the consumer and the merchant. The first transaction processor may perform various types of aggregation. For example, the processor may aggregate cost data associated with low-priced sales transactions between with the merchant and at least two consumers or aggregate cost data associated with low-priced sales transactions associated with two or more merchants. Various payment methodologies may be implemented between the merchant and consumer. For example, the consumer may pay the merchant for the low-priced sales transactions on a pay-per-use basis, a pre-paid basis, a subscription basis, a post-paid basis, or other similar basis. The store data that represents each individual low-priced sales transaction may accessible by various banking entities such as the acquiring banking entity or an issuing banking entity associated with the consumer. The stored data that represents each individual low-priced sales transaction may also be accessible by the consumer. To provide customer service, the first transaction processor may direct a consumer request to the second transaction processor for providing customer service. Each processor may be located at various locations. For example, the first transaction processor may be located at an issuing banking entity associated with the consumer. The payment processing system may further include a third transaction processor that tracks reconciling of a payment with at least one of the low-priced sales transactions. This third transaction processor may be located at an acquiring banking entity. The system may also include a fourth transaction processor that translates the aggregate cost data into a format for a third party. This fourth transaction processor may be located in a server that includes the first transaction processor. Security methodologies may be included in the payment processing system. For example, the stored data that represents each individual low-priced sales transaction may include a one-way hash of an account number associated with one or more of the transactions. Correspondingly, the stored data may be decrypted for access. One or more of the low-priced sales transactions may occur at a kiosk device. The payment processing system may also include a third transaction processor that aggregates cost data associated with low-priced sales transactions between the consumer and another merchant. In some embodiments, the merchant may provide the consumer with preferential treatment to encourage future transactions with the merchant.

In accordance with another aspect of the disclosure, a method of processing payments includes receiving data that represents one low-priced sales transaction between a consumer and a merchant. The method also includes aggregating the cost of the low-priced sales transaction and the cost of another low-priced sales transaction between the consumer and the merchant. Furthermore, the method includes storing data associated with each low-priced sales transaction such that the data is accessible by one or more banking entities associated with the merchant. The method also includes sending data that represents the aggregate cost to an acquiring banking entity associated with the merchant.

In one embodiment, the method may also include aggregating the cost of a low-priced sales transaction associated with the consumer and the cost of a low-priced sales transaction associated with another consumer. Furthermore, the method may include aggregating the cost of a low-priced transaction associated with one merchant and the cost of a low-priced sales transaction associated with another merchant in which both merchants are associated with the acquiring banking entity.

In accordance with another aspect of the disclosure, a computer program product residing on a computer readable medium has instructions that, when executed by a processor, cause that processor to receive data that represents a low-priced sales transaction between a consumer and a merchant. Additional instructions cause the processor to aggregate the cost of the low-priced sales transaction and the cost of another low-priced sales transaction between the consumer and the merchant. Instructions also cause the processor to store data associated with each low-priced sales transaction such that the data is accessible by one or more banking entities associated with the merchant. Also, instructions cause the processor to send data that represents the aggregate cost to an acquiring banking entity associated with the merchant.

In one embodiment, the computer program product may include additional instructions to aggregate the cost of a low-priced sales transaction associated with one the consumer and the cost of a low-priced sales transaction associated with another consumer. Instructions may also be included to aggregate the cost of a low-priced transaction associated with one merchant and the cost of a low-priced sales transaction associated with another merchant.

Additional advantages and aspects of the present disclosure will become readily apparent to those skilled in the art from the following detailed description, wherein embodiments of the present invention are shown and described, simply by way of illustration of the best mode contemplated for practicing the present invention. As will be described, the present disclosure is capable of other and different embodiments, and its several details are susceptible of modification in various obvious respects, all without departing from the spirit of the present disclosure. Accordingly, the drawings and description are to be regarded as illustrative in nature, and not as limitative.

### BRIEF DESCRIPTION OF THE DRAWINGS

FIG. 1 is a block diagram representing a large scale payment system.

FIG. 2 is a block diagram that represents a distribution of processors within the large scale payment system shown in FIG. 1 to reduce transaction costs.

FIG. 3 is a block diagram that represents the locations of servers that include the distributed processors.

FIG. 4 is a block diagram that represents functional modules that are included in the distributed processors.

FIG. 5 is a block diagram that represents functional modules that may be included in the distributed processors.

FIG. 6 is a flow chart that represents operations associated with a low-priced transaction.

FIG. 7 is a block diagram that represents operations associated with a single merchant that are executed among the distributed processors.

FIG. 8 is a block diagram that represents operations associated with multiple merchants that are executed among the distributed processors.

FIG. 9 is a block diagram that represents a Merkle tree.

FIG. 10 is a block diagram that represents a router that may be included in each distributed processor.

FIG. 11 is a block diagram that represents a node of distributed processors.

FIG. 12 represents a portion of a billing statement and a graphical user interface.

FIG. 13 represents a graphical user interface that provides a transaction breakdown.

FIG. 14 represents a graphical user interface that identifies an individual transaction.

FIG. 15 represents a graphical user interface associated with customer service.

FIG. 16 represents a graphical user interface associated with receiving a service request from a customer.

FIG. 17 represents a graphical user interface that presents a customer request to a service provider.

FIG. 18 represents a graphical user interface that presents aggregated low-priced transaction information.

### DETAILED DESCRIPTION OF THE EMBODIMENTS

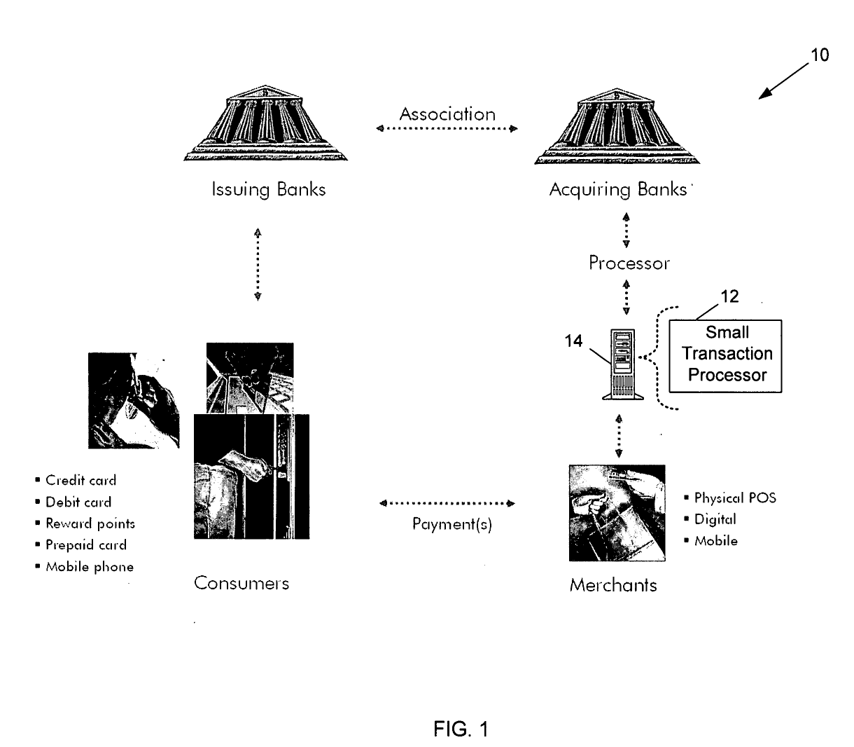

Referring to FIG. 1, a large scale payment processing system 10 is illustrated that substantially reduces the transactions costs of low-priced purchases. This illustrative example includes consumers that purchase goods and/or services from merchants. A banking institution, known as an acquiring bank, provides the merchants with an account for accepting payments. Another banking institution, know as an issuing bank, provides consumers with an instrument (e.g., a credit card, debit card, prepaid card, etc.) for making electronic payments. An association, also known as a card network, manages the relationships among the issuing bank and the acquiring bank. In some arrangements, a third party known as a processor handles transactions among merchants, acquiring banks, issuing banks, and associations. Throughout this discussion, the financial service institutions (i.e., acquiring banks, issuing banks, associations, and processors) may be referred to as FSIs.

By producing and distributing small payment applications that enable merchants, acquiring banks, issuing banks, processors, and associations to capitalize on small payments, widespread consumer trust of and preference for credit and debit cards may be leveraged. To that end, a small transaction processor 12 is executed on a server 14 that is in communication with the merchants. Small transaction processor 12, which may be implemented in hardware, software, or a combination of hardware and software is designed to substantially optimize revenue and profits for small transaction processing by extending the existing payments infrastructure.

In some arrangements, small transaction processor 12 is an expandable transaction processing platform that enables merchants, acquiring banks, issuing banks, processors and associations to grow and develop via small payments. By efficiently and economically operating on small payments, small transaction processor 12 may substantially reduce the transaction costs of low-priced purchases by aggregating related purchases. Small transaction processor 12 also allows consumers to make purchases with their preferred payment instrument (e.g., credit card, debit card, etc.). By functioning in either digital, mobile, and physical POS environments, operations of small transaction processor 12 may integrate seamlessly into the merchant buying experience as a credit-card gateway, with no visible change in the consumer's buying experience. Through its operations, the merchant is given a tool to build a profitable relationship with their customers through a blend of potential business models: pay-per-use, pre-paid, subscription, and post-paid. Small transaction processor 12 may also improve customer satisfaction and lower customer service costs through integrated bill presentment and dispute resolution. Along with lower transaction costs, use of small transaction processor 12 may bring cost-effective loyalty, promotions, and fraud management technologies to the small payment market.

Small transaction processor 12 provides benefits for various parties included in payment processing system 10. For example, typically consumers want purchasing flexibility. They want to control what they buy, when they buy it, and how they pay for it. But merchants frequently impose restrictions on card usage for small payments and ultimately, may not offer the convenience that consumers desire. Merchants want to make it easy for consumers to buy their goods and/or services. But for smaller transactions, card processing and customer service costs eat much—if not all—of the merchants' profits. When the consumer uses their preferred credit or debit card to pay for low-priced items, merchants' proceeds may disappear.

Small transaction processor 12 operates substantially invisible to the consumer. The consumer does not need to download software, create or pre-fund an account, or spend a minimum amount to purchase. However, the consumer may relatively quickly review their transactions online. For consumers, payment processing system 10 allows them to make small purchases using the trusted and preferred payment mechanisms (cards) that they already possess. The system gives them easy access to low-priced digital, mobile, and physical POS goods and services along with making purchases by using various types of business models (e.g., pay-per-use, pre-paid, subscription, or post-paid).

Additionally, merchants want to provide consumers with desirable merchandise and convenience. By offering flexible payment options, payment processing system 10 provides convenience. Merchants also like to offer the wide array of payment choices for all purchases, yet costly transaction processing and customer service fees prevent merchants from earning profits on small credit and debit card purchases.

Payment processing system 10 enables profitable transactions for small payments. The system reduces two significant costs associated with small and micro payments—transaction processing costs and customer service costs. Payment processing system 10 tackles transaction costs with an aggregation methodology. By allowing merchants to aggregate small payments, and modify and adjust aggregation settings, the system increases efficiencies. In one arrangement, portions of payment processing system 10 is implemented online (via the Internet). In such an arrangement, automated customer service is provided to deliver responsive customer service at a relatively low cost. Payment processing system 10 also allows merchants to craft business-model offerings that optimize consumer acceptance.

For merchants, payment processing system 10 helps merchants to grow both their top-line (revenue) and their bottom-line (profits) via low-priced goods and services. The system also offers business model flexibility by supporting, for example, pay-per-use, subscription, pre-paid, and post-paid payment schemes. Additionally merchants are provided the cost and customer satisfaction benefits of cost-efficient customer self-care.

Acquiring banks and payment processors may be interested in offering products that meet the needs of merchant customers and increase overall transaction volumes. However, acquiring banks and processors have typically been unable to provide merchants with a cost-effective solution for small payments. Disproportionately high fixed and variable fees associated with traditional payment processing adversely affect merchants' profit margins. The alternatives, such as implementing the use of prepaid cards or minimum purchase amounts, may impose economic or time disincentives on consumers.

By incorporating small transaction processor 12, processors and acquiring banks may enable profitable new business models for merchants. Merchants may accept preferred payment instruments (credit and debit cards) for small and micro transactions and remain profitable. With a new class of transactions flowing through the system, processing volume may grow and with it, revenue for the acquiring bank and the processor. In general, small transaction processor 12 may be integrated into existing processing systems, and the systems of the processor's merchants. For acquiring banks and processors, payment processing system 10 may increase transaction flow—that brings both revenue and profit benefits.

Issuing banks want their cards to be “top of wallet” whenever their cardholders transact. But for small purchases, high processing and customer service costs discourage merchants—both digital and physical—from accepting credit and debit cards. As a result, the issuing bank may lose market share to cash and alternative payment systems.

With the functionality of payment processing system 10, issuing bank's cardholders may appreciate the increased convenience of using cards to purchase low-priced goods, instead of cash. The purchasing process is familiar and quick, and requires no account registration. Payment processing system 10 with its aggreation functionality may reduce the issuing bank's customer service costs for small payments. In some conventional systems, real-time customer service responses may cost up to ten dollars per incident, especially for low-margin small payments. Maintaining such pricey customer service for small payments is insensible. Payment processing system 10 offers online customer self-service, specifically designed for small payments, which may provide responsive service at a relatively low cost. For issuing banks, payment processing system 10, converts cash and check spending to cards, thereby increasing transaction flow. Small transactions increase the frequency with which consumers transact, bringing “top-of-wallet” market share gains to the cards that consumers use. Payment processing system 10 reduces costs with online customer self-care. Additionally, some economic aspects of aggregating economics removes a impediment to merchant rollout of small-payment oriented issuing products such as contact-less payment cards.

In general, current standard fee structures for transaction processing prevent the possibility of profitable small and micro-payments. Without a response, card networks may lose a portion of the rapidly developing market for low-priced digital goods.

Payment processing system 10 may enable cardholders and merchants to make and accept card payments, instead of cash, for low-value items. Consumers may appreciate increased convenience, as the purchasing process remains familiar and relatively quick, and needs minimal (if any) account registration. Payment processing system 10 assists card association members by reducing customer service costs for small payments. Typically, conventional real-time customer service responses and chargeback fees are very costly, especially for low-margin small payments. In contrast, payment processing system 10 offers an intuitive online customer self-service, specifically for small payments, that is designed to deliver responsive customer service at a relatively low cost.

Payment processing system 10 increases transaction flow by converting low-value cash and check payments into card payments. The system also defends the card payment system against entree from competitive payment forms. Furthermore, profitable small payments are enabled within the card network.

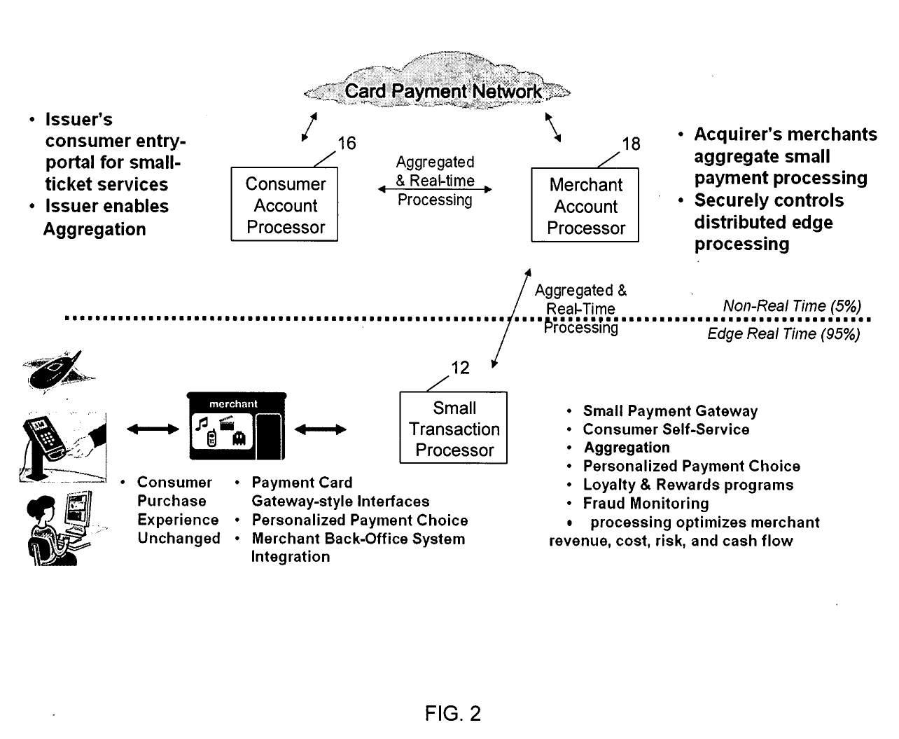

Referring to FIG. 2, small transaction processor 12 may be deployed as either a software product owned and operated by a single party in payment processing system 10, or it may be used by multiple parties as an outsourced service.

In general, small transaction processor 12 includes such capabilities as providing a small payment gateway for transporting payments from merchants into payment processing system 10. Online customer self-service is also provided by payment processing system 10 which may be implemented independent or into an pre-existing merchant service interface. Payment processing system 10 also includes a customer account processor 16 and a merchant account processor 18 that assist with the aggregation computations (e.g., aggregations transactions from a single merchant). Additionally, processors 12, 16, and 18 provide the ability to adjust aggregation parameters and with allowing merchants to substantially optimize transaction costs, interchange qualification, cash flow, risk costs, and customer service. The one or more of processors 12, 16, and 18 may also includes technology for performing aggregations through issuing banks.

The flexibility of the design of payment processing system 10 provides for implementation in high volume transaction banking and processing environments. For example, merchant account processor 18 may be designed to provide merchant account service for acquiring banks and their processors. Consumer account processor 18 may also provide service functionality for issuing banks and their processors. Payment processing system 10 may also be architected to enable FSIs to maintain control over distributed processing through cost-effective, secure, distributed auditing.

The design of payment processing system 10 may address design concepts such as scalability, reliability, and security. For example, small transaction processor 12 may be designed with a scale factor of one thousand or more for handling a substantial portion of the small transaction economy. Along with scalability, multiple levels of security may be implemented into payment processing system 10 to address both security issues within the system and external to the system. By implementing an expandable design, additional functionality may be incorporated at a later time to address merchant and consumer concerns.

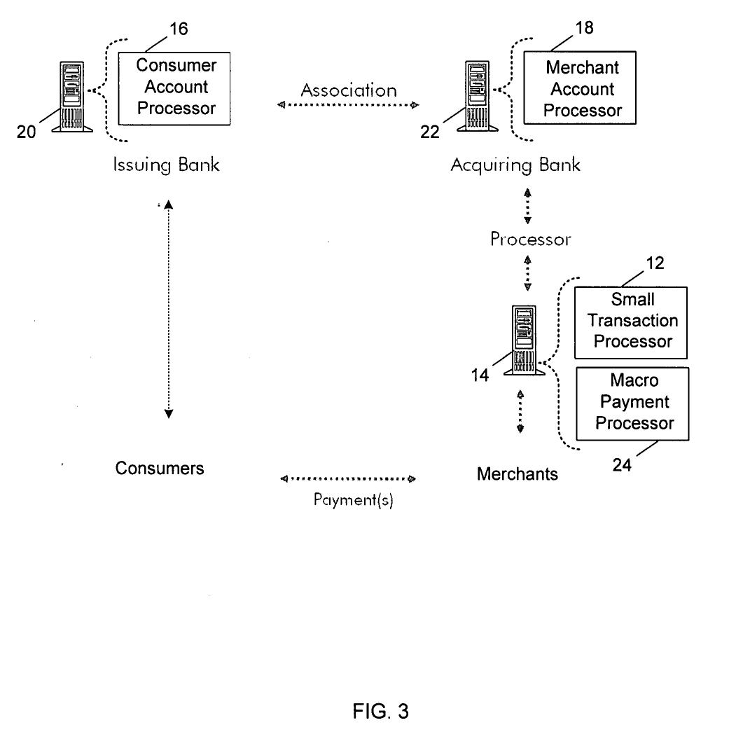

Referring to FIG. 3, one exemplary arrangement, small transaction processor 12, consumer account processor 16, and merchant account processor 18 are included in respective servers 14, 20, and 22. In this arrangement, servers 14, 20, and 22 are respectively located at an issuing bank, acquiring bank, and a location external to a merchant. However, in other arrangements, the servers and processors may be located at other venues. Furthermore, in this arrangement, a macro payment processor 24, described in detail below, is executed on server 14.

The small transaction processor 12 processes micro-transactions and provides a traditional payment card gateway interface for authorize, capture, sale, credit and void transactions. Small transaction processor 12 stores micro-transaction data for merchant financial management and payment reconciliation, customer service, and marketing management. Small transaction processor 12 also provides the consumer with detailed self-service interfaces. Small transaction processor 12 may be designed to be executed on the location of the merchant, or, as represented by the figure, the small transaction processor may be executed by a 3^{rd} party processor on behalf of a merchant, a group of merchants, or an FSI.

Consumer account processor 16, aggregates small transactions for a set of consumer accounts into larger transactions. Consumer account processor 16 is the initial interface for consumer self service and provides a single-signon portal for customer service that dispatches the consumer to the appropriate small transaction processor for self-service. In this arrangement, consumer account processor 16 is executed on server 20 at an issuing bank. Alternatively, consumer account processor 16 may executed on a server located at a 3^{rd} party processor for a group of merchants or an FSI.

Merchant account processor 18 reconciles payments for large transactions to each individual small transaction (that respectively aggregate to produce the large transactions). Merchant account processor 18 provides an interface between the aggregated settlement systems of the banking industry and the individual settlement systems of the merchant. Similar to the other processors described above, merchant account processor 18 may be executed by a 3^{rd} party processor on behalf of any type of FSI. However, in this illustrative example, merchant account processor 18 is executed on server 22 that is located at an acquiring bank.

Macro payment processor 24 interfaces consumer account processor 16 and merchant account processor 18 to 3^{rd} party payment processors that process large payments. To provide this interface, macro payment processor 24 translates data and messages into one or more formats used by the 3^{rd} party payment processors. For example, translations for 3^{rd} party payment processors such as First Data, Paymentech, Vital, etc. may be implemented. In this particular arrangement, macro payment processor 24 is executed on server 14 that executes small transaction processor 12. However, in some arrangements macro payment processor 24 may be executed on a server at another location (e.g., at a merchant's location).

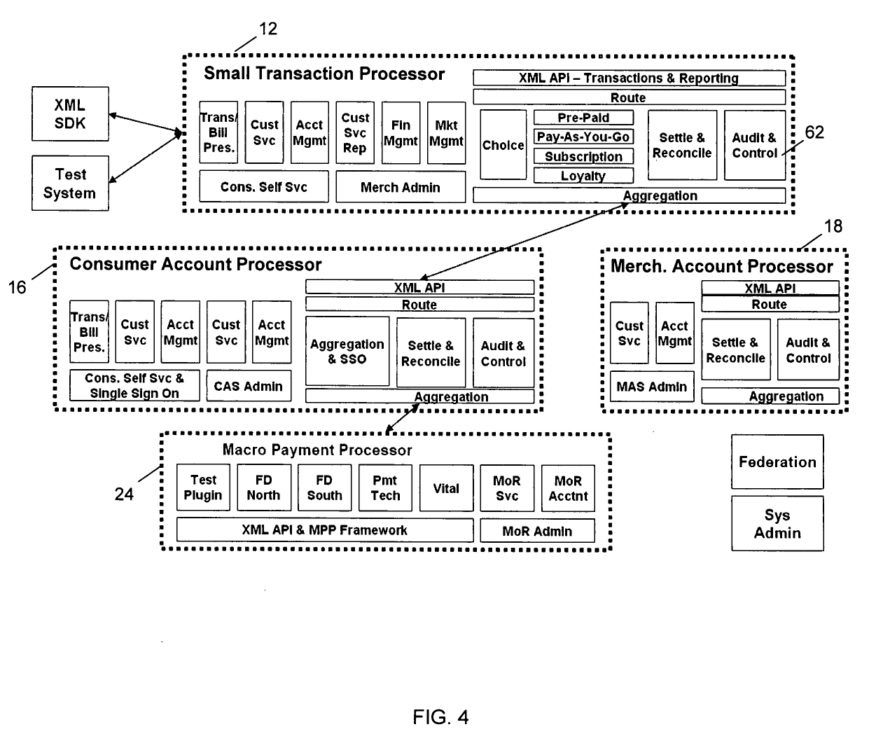

Referring to FIG. 4, a block diagram is presented that represents some of the functionality provided by small transaction processor 12, consumer account processor 16, merchant account processor 18, and macro payment processor 24. In this particular implementation, each processor includes some similar components. In particular, each of the processors 12, 16, 18, and 24 include engine components that implement distributed processing application program interfaces (APIs) for transaction processing. Additionally, each processor includes user interfaces and reporting API components that present transaction data and allow for interactive use of the system.

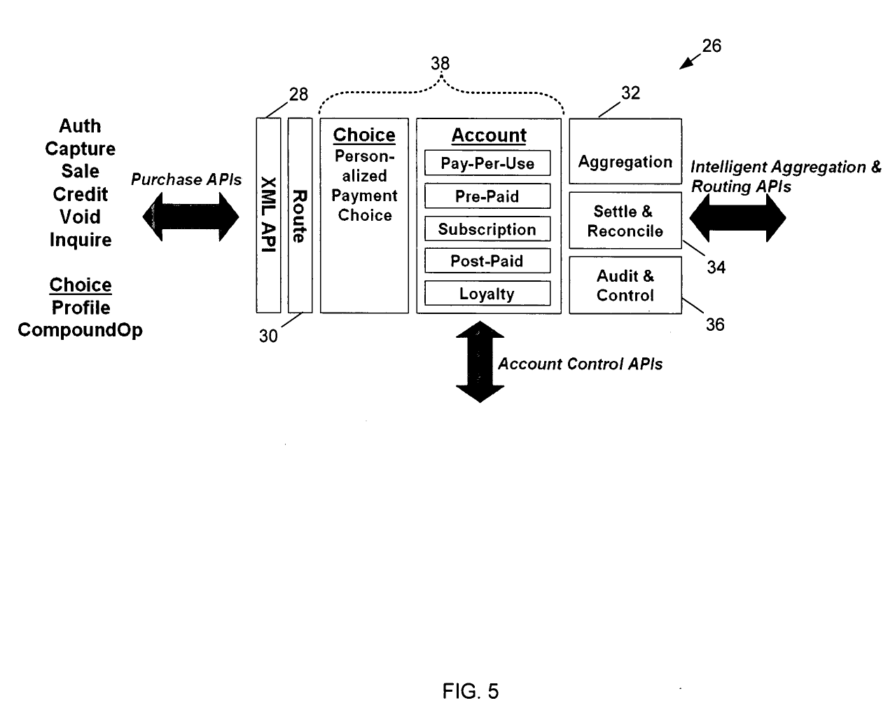

Referring to FIG. 5, a block diagram is shown that represents a distributed processing engine 26 that is included in each of the processors 12, 16, 18, and 24 shown in FIG. 4. Distributed processing engine 26 includes an extensible markup language (XML) API 28 and a distributed transaction router 30 for sending and receiving messages and data to and from other processors. Distributed processing engine 26 also includes an aggregation component 32 for aggregating a small amount of low-priced transactions. Aggregation component 32 may assist in computing various types of aggregations. For example, low-priced transactions may be aggregated on a consumer basis. To assist an issuing bank, low-priced transactions may be aggregated based on one or more merchants. Distributed processing engine 26 also includes a component 34 that assists in the settlement and reconciliation of individual transactions and/or aggregated transactions. Additionally, engine 26 includes a component 36 to assist with auditing transactions and providing security to the transactions and data (e.g., credit card numbers, account numbers, etc.) associated with the transactions.

Along with the components mentioned above, a distributed processing engine incorporated into the small transaction processor 12 may include additional components. For example, a personalized payment component 38 may be included for providing a user with different methodologies for making payments. For example, a user may select from payment methodologies such pre-payment, subscription, post-payment, pay-as-you-go, and/or a loyalty based payment system. Along with small transaction processor 12, other processors in payment processing system 10, may include additional components. For example, consumer account processor 16 may include a component that allows consumers access into payment processing system 10. By providing access, a consumer may be directed to an appropriate small transaction processor to review one or more transactions.

Small transaction processor 12 is integrated into the merchants purchase experience as a payment-card gateway, with substantially little, if any, change in a consumer's buying experience. At some point in the merchant's purchase experience, transactions are presented to a payment card gateway interface for authorization and settlement (or denial). When pointed to the XML payment card gateway APIs, the merchant transmits similar payment card transaction information and receives a substantially real-time micro-payment authorization and settlement (or denial). There is substantially no apparent difference to a consumer's buying experience.

As a payment card gateway, small transaction processor 12 is capable of handling payments for various types of business models. For example, payment processing system 10 allows consumers make purchases with their preferred payment instrument (e.g., a credit card, a debit card, through a payment intermediary such as Paypal, etc.). Furthermore, while payment processing system 10 provides uniquely efficient processing for small transactions, the system is also capable of processes transactions of any size.

Via processors 12, 16, 18, and 24, payment processing system 10 channels the information in macro-payment transaction verification processes such as AVS, CVV2 checks, fraud checks, and 3D-Secure validation into the micro-payment authorization control flow. Merchant software that processes this information and makes merchant-level decisions about whether a particular customer should be allowed to transact typically continues to function in a similar manner.

Payment processing system 10 “extends the rails” of conventional production payment card systems, providing open, easy-to-adopt technology that substantially moves real-time micro-payment transaction processing to the network edge while maintaining full compatibility with today's production payment card systems.

Payment processing system 10 receives electronic payment transactions from various types of client software systems. For example, transactions may be received from POS devices that operate at the attended-commerce physical-world point of sale, and are designed to funnel card-present transactions to the existing payment card networks. Kiosk devices that operate at the unattended-commerce physical world point of sale and also conduct card-present transactions may provide electronic payment transactions. These devices typically support sophisticated graphical user interfaces (in comparison to POS devices), since Kiosk devices are designed to interact directly with the consumer with little or no support from an attending cashier. Payment processing system 10 may also receive electronic payment transactions from Internet websites or webpages (or other types of eCommerce systems) that conduct card-not-present transactions. Mobile interfaces to mobile commerce applications that conduct a mix of card-present and card-not-present transactions may provide transactions.

For each type of client mentioned above, there are a variety of architectures for interfacing merchant applications to payment processing system 10. For example, for client-side customization, the business logic that adapts the client to payment processing system 10 may be coded in a client server or a server associated with the merchant. The business logic that adapts the client to payment processing system 10 may be implemented at an interposing server that may be located between the client and the third party that controls the system. The business logic that adapts the client to the payment processing system may be implemented as a server-side module (e.g., a plug-in module) to the payment processing system via merchant plug-ins. Also, one or more of processors 12, 16, 18, and 24 included in payment processing system 10 may be transparently integrated into the systems of an existing payment processor. Such an integration may include minimal (or substantially no) changes to the systems of the merchants that are already using the pre-existing payment processor. In general, each type of API included in payment processing system 10 may accommodate one or more of these approaches.

The personalized payment choice provided by payment processing system 10 typically implements four types of payment models: pay-per-use, pre-paid, subscription, and post-paid. Payment processing system 10 supports each of these models on a single transaction processing platform. Payment processing system 10 also may support blended models in which merchants operate under one or more of the models simultaneously and consumers may dynamically choose a preferred purchase method.

Personalized payment choice provides the merchants with the ability to define a set of “Account Types” that they accept as payment within the business. Account types may be specific to the merchant, for example one merchant may define a prepaid account for phone time rather than another merchant defining a subscription account for downloaded music. Account types have an underlying “unit type”, which is the unit type of balances in accounts of this type—e.g. US Dollars, minutes of phone time, minutes of game time, or candy bars. The extensible set of unit types allows for the implementation of loyalty currencies.

Accounts, which are instances of an account type, are typically owned by a consumer and backed by an “instrument”. The instrument serves to identify the consumer, and may be a key basis for authenticating access to the account. Examples of instruments include credit cards, debit cards, gift cards, RFID-based smart cards, RFID-based mobile tokens, or website account identifiers. The instrument is the source of macro-payment funds in the system, and may in fact be the only token identifying the consumer for this account. Consumers can optionally have a login (name, password), and can associate that login with one or more instruments and the accounts associated with the instruments. Referring to Appendix A, one exemplary set of information is shown that may be included in each account.

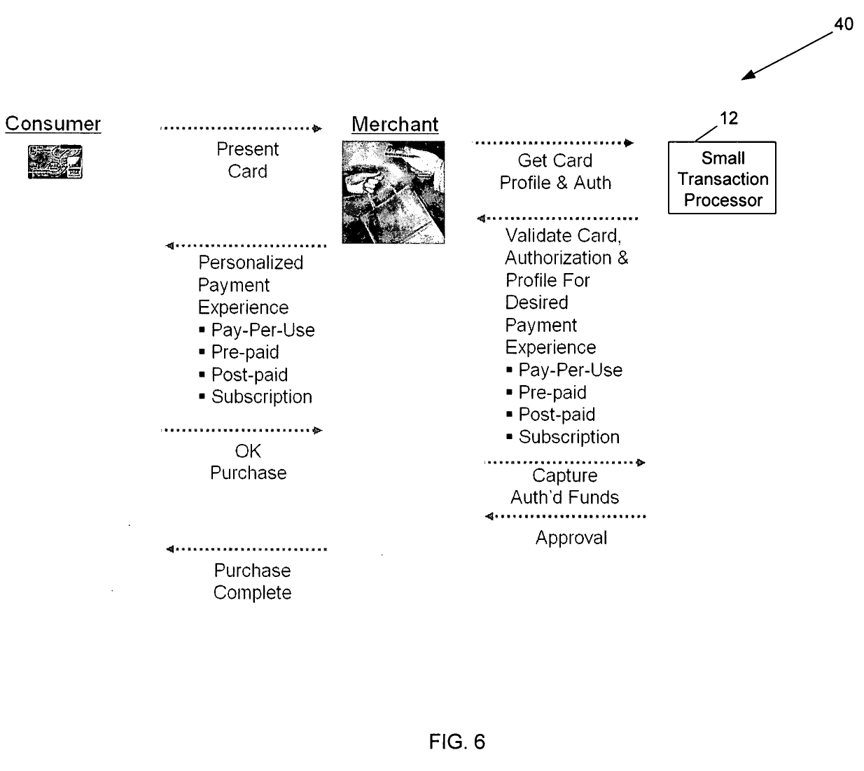

Referring to FIG. 6, a flow chart 40 presents a series of operations that describes a personalized payment choice and involves the following API-level interactions between the merchant and small transaction processor 12. To begin a typical transaction, a consumer may present an instrument to the merchant. The merchant passes the instrument to small transaction processor 12. Small transaction processor 12 validates the instrument and returns a personalized payment profile associated with the instrument. The profile describes an extensible list of accounts that have been defined to work with the instrument, along with parameters defining how new accounts can be added to the instrument profile.

The merchant uses the information in the profile to present a payment experience to the consumer that is customized to the consumer's preferences and the merchants defined business models. The consumer completes the purchase transaction as desired, and the merchant captures the finds from the consumer as determined by the chosen payment account. Typically, the APIs support two styles of interaction such as single-account purchases that correspond to standard payment card transactions. Additionally, compound, multi-account, purchases may be supported. For example, a multi-account purchase may combine a US dollar transaction with a loyalty point update, or a Japanese yen transaction with a free coffee update.

Typically, each of the payment accounts support a common set of purchase APIs. This allows the merchant to code their transactions in a manner that is independent of the consumer payment choice. A list of typical purchase requests are shown in Appendix B.

In the “pay-per-use” model the consumer pays for each transaction completed. From the merchant's point of view, this model is advantageous since the pay-per-use model provides a relatively high take rate among consumers. The simple terms of this model encourages consumers to try the merchant's products and the offering establishes a unit value-point for the merchants product. However, the pay-per-use model also includes some challenges for the merchants. For example, if a consumer is “low volume” customer, the relationship is often unprofitable. Transaction costs can be relatively high and the relationship is often anonymous. In addition to the API purchase requests, for pay-per-use accounts, the payment processing system also may support two additional requests (that are described in Appendix C).

In the “pre-paid” model a consumer pre-purchases a set of transactions. From the merchant's point of view this model may be advantageous since the consumers commit to more than one transaction with the merchant, and may often exceed their initial commitment. The risk of extending credit to the consumer is lowered because the consumer has paid up-front. Pre-paid provides a platform for promotional activities including volume discounts, gift cards and accounts, teen accounts, and offerings that reach the un-banked. Additionally, pre-paid top-up amounts can be tuned to amortize transaction costs over many micro-transactions. Along with the advantages, the pre-paid model also poses challenges for the merchant. For example, a lower take rate versus pay-per-use, may need a substantial sales effort to offset pay-per-use. Another potential challenge is the need to provide incentives such as volume discounts. The expenses of issuing a branded pre-paid card may be substantial: $2-$3 for card issue and charging costs at the point of sale, 15-40% for distribution to a card-rack at the point of sale, 2% per-transaction costs, and customer support costs. The cost of complying with emerging regulations such as state-imposed escheatment of unclaimed pre-paid funds is another challenge. As described in Appendix D, in addition to the purchase requests, pre-pay accounts support additional requests.

In a “subscription” model, the consumer commits to pre-purchase a set of transactions for a specified time period. From the merchant's point of view some of the advantages of this model may include that a consumer agreement to purchasing by subscription indicates a deep level of commitment to the merchant (which can lead to a deeper relationship between merchant and consumer). The consumer may also become a recurring source of revenue for the merchant. The risk-of extending credit to the consumer may be reduced.

A subscription model also introduces challenges for the merchant. For example, continuing financial commitment may lower the take rate. To boost take rate, a merchant may resort to substantial discounts on the product offering. The subscription business model may not be applicable with all product types. As shown in Appendix D, subscription accounts may use the requests supported by the pay-per-use requests along with some additional types of requests.

In the “post-paid”, or “billing” model, the merchant accepts consumer transactions without securing payment in advance. Rather than securing payment, the merchant instead periodically bills the consumer for the transactions. From the merchant point of view, this model is advantageous since consumers may often spend freely and conduct a large number of transactions with the merchant. The consumer may become a recurring source of revenue to the merchant. The model is tailored to service offerings where the merchant might expect that some consumers may be highly motivated to keep their accounts in good standing (e.g., residential telephone or electric power service).

Post-paid challenges for the merchant include the merchant taking on a large credit risk with a substantial risk of non-payment. However, the risk may be alleviated by keeping the post-paid billing periods relatively short. Additionally, the model may not operate for many product categories. Post-paid accounts support all the requests supported by the pay-per-use requests, including some additional requests that are listed in Appendix E. Furthermore, Appendix F presents a variety of arguments that are used by the purchase and account APIs.

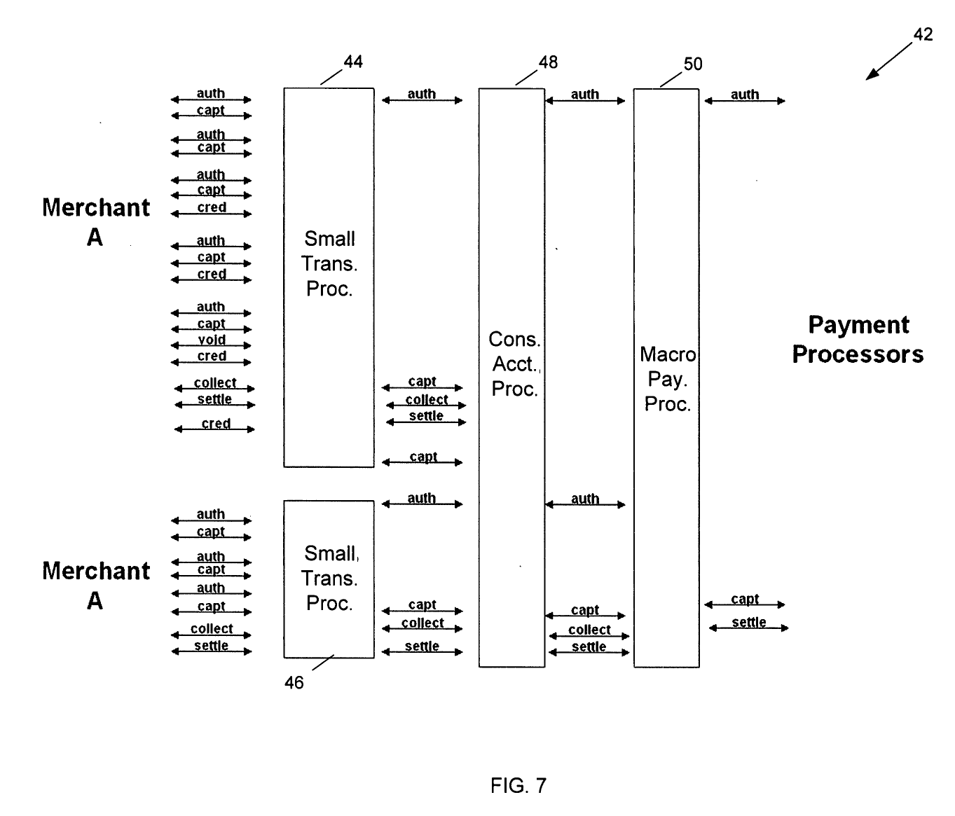

Referring to FIG. 7, a block diagram 42 is shown to illustrate the interactions of small transactions processors 44, 46, consumer account processor 48, and macro payment processor 50 that maybe included in some embodiments of payment processing system 10. As mentioned above, aggregating relatively low-priced transactions into one larger transaction provides a methodology to reduce transaction costs. In general, transaction aggregation includes turning many small micro-transactions into one large macro-transaction. By aggregating, the fixed costs associated with processing a macro-transaction can be spread over multiple micro-transactions. As shown in the figure, each transaction is illustrated through three phases that are experienced by the merchant: authorization, or auth, checking cardholder payment credentials and reserving the funds required for the transaction, capture, or capt, completing the transaction with the cardholder, and the final settle message that matches up financial institutions to the transaction that instigated by the payment.

In this example, small transaction processors 44, 46 receive a stream of payment card auth, capture, sale, credit and void micro-transactions from a merchant's systems. Although in other arrangements, small transaction processors 44, 46 may receive micro-transactions from multiple merchants. Each small transaction processor 44 and 46 cooperates with consumer account processor 48 associated with a particular payment card to aggregate the micro-transactions into a smaller number of macro-transactions. Consumer account processor 48 in turn uses a macro payment processor 50 to send data that represents the large transactions to 3^{rd} party payment networks. In this particular arrangement, a merchant account processor is not included in real-time transaction flow.

As an illustrative example to demonstrate the cost benefits of transaction aggregation, suppose that a sequence of transactions above netted out to 5 micro-transactions for a $0.99 charge. If the transaction processing fees at the macro-transaction level were $0.10 for a gateway, $0.10 for an acquiring bank and $0.10+2%, for interchange then five $0.99 macro-transactions would require $1.60 in fees, or 32% of the transaction amount. In contrast, if the five transactions provided to a payment processing system that charges $0.05 per transaction, then the total fees for the five micro-transactions would be $0.55, or 11% of the transaction amount, a savings of $1.05 or 21%.

By implementing processors 44, 46, 48, and 50 that incorporate aggregation engines, a set of policies for enabling small-transaction business models are implemented. By implementing the aggregation, merchant profitability may increase by reducing transaction costs. However, rather than just minimizing cost, in some arrangements, aggregation is implemented in such a manner to balance a number of factors. For example, factors involving a tradeoff between reducing transaction costs (by increasing the aggregation time) may be balanced other factors such as cash flow delays and fraud risk avoidance. By substantially optimizing the tradeoffs among these factors (e.g., accounting for a merchant's cost of funds and fraud rates), aggregation may be provided without a substantial negative impact (e.g., reducing cash flow delays, exposure to risky transactions, increased customer service costs, etc.).

Typically, charges that associations such as Visa and MasterCard require their member acquiring banks to pay to their member issuing banks vary with interchange classification. Interchange classification involves many rules. Visa and MasterCard define at least eighty or more interchange classes with various rates and rules. Interchange classifications are assigned on a transaction-by-transaction basis, and may be determined by many factors. For example, some factors related to merchants may include a merchant business category (MCC code), whether the merchant has a card-present business or a card-not-present transaction business, whether the card-not-present business is mail order/telephone order or eCommerce, whether there are unattended sales situations, and/or whether the associations regard this as an “emerging” market that merits special rates. Another classification factor may relate to the consumer payment instrument used (e.g., credit, debit, debit, corporate, purchase, specially branded cards, EBT card, a card from a foreign issuer, etc.). Transaction-time details of the transaction may also be a factor. For example, is there a valid card swipe, a signature, or signature debit versus PIN debit, is there an AVS match, CVV match, or Verified-By-Visa/Secure Code match, is the transaction small enough for the given interval, and/or is there a $1 pre-auth for the transaction. Similarly, post-transaction details of the transaction may factor. For example, the elapsed time between auth and capture, capture and settlement, or auth and settlement, is the authorization amount equal to the capture amount, or are details such as customer service phone numbers or website addresses provided at settlement.

If all of the requirements of a merchants “best” interchange classification are met, then the transaction is typically referred to as being “fully qualified”. If the requirements of the interchange classification are not met, then the transaction may be downgraded to a new “mid-qualified” interchange class (currently, either Visa EIRF or MasterCard Merit 1). If the requirements of the mid-qualified class are not met, then transactions may be downgraded to “unqualified” (currently Visa Standard or MasterCard Standard). Certain interchange classes may have intermediate mid-qualified downgrade classes (e.g., a downgrade to MasterCard Key Entry would be taken before Merit 1 if the only defect in the transaction was a missing track swipe).

The merchant's fully qualified interchange categories are one set of inputs to assist with the aggregation. Merchants in a single line of business generally have a single interchange classification. Those with more complex businesses may have several classifications depending on which business line conducts the transactions, although typically these business lines have different merchant accounts. Aggregation capability of payment processing system 10 accommodates complex businesses by allowing each business to maintain a separate profile that is used during an aggregation.

The cost advantage of aggregation is governed by two basic measures of consumer purchase behavior—how much do they buy, and how often do they buy. The purchase amount may be represented as Pᵢ, which is the amount that the consumer spends with each purchase, and the purchase inter-arrival time may be represented as Tᵢ, which is the amount of time between purchases for a given consumer at a given merchant. A consumer's purchase behavior at a merchant can be viewed as a sequence of amounts and inter-arrival times: P₁ . . . T₂ . . . P₂ . . . T₃ . . . P₃ . . . T₄ . . . P₄ . . . T₅ . . . P₅.

Aggregation substantially optimizes the tradeoff between interchange classification and the benefits of putting more micro-transactions within an existing “aggregation window” by optimizing the timing between macro-auth and macro-capture/macro-settlement. Furthermore, aggregation substantially optimizes the benefit of aggregation versus the potential cost impact of interchange downgrade.

Referring to Appendix G a table is provided that describes the parameters that a merchant can set to control the aggregation. Payment processing system 10 substantially optimizes aggregation on a transaction-by-transaction basis under control of the parameters set by the merchant. In some arrangements, these parameters may be considered complex, but the default settings may provide substantially optimized aggregation results without requiring the user to learn or gain an understanding of the aggregation parameters. Typically, payment processing system 10 performs aggregations that operate within association compliance guidelines, keeping single-merchant aggregation compliant with association rules.

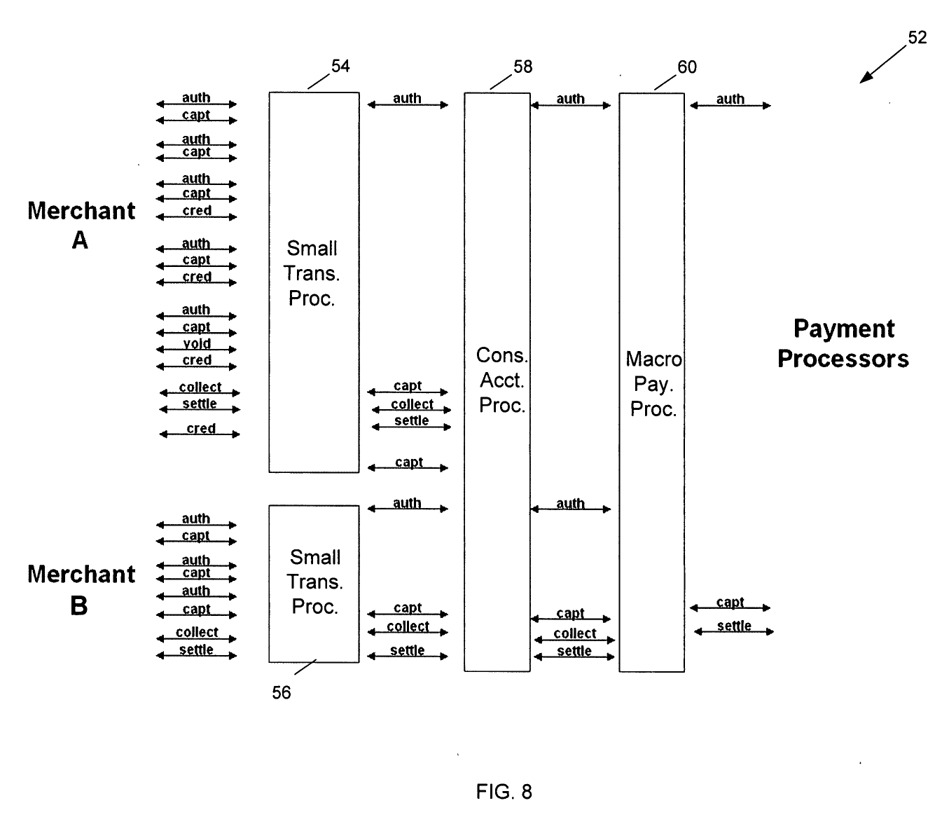

Referring to FIG. 8, through aggregation, a payment processing system 52 may aggregate low-priced transactions universally across many consumers, merchants and/or payment providers. Payment processing system 52 expands transaction aggregation by moving the bulk of micro-payment processing from a payment network core to distributed processors such as small transaction processors 54, 56, consumer account processor 58, and micro-payment processor 60 while maintaining a secure payment processing system.

Payment processing system 52 may include a cryptographically secure selection (CSS) module that allows for massive distribution of payment processing, while maintaining secure centralized control. In this arrangement, the CSS module separates system operations into two layers. The first layer is a distributed real-time micro-payment processing layer in which consumer micro-payment transactions with merchants are recorded on a small transaction processor (e.g., small transaction processor 54). The second layer is a macro-payment and distributed control layer that operates in non-real-time and interfaces to existing payment networks.

Typically, the micro-payment and macro-payment layers communicate. For example, policies to control real-time transactions are fetched (as needed) by the micro-payment layer associated with a small transaction processor, and cached by that layer. These policies may, for example, authorize multiple micro-payment transactions as long as they pass real-time fraud checks. Typically, the micro-payment layer communicates summary settlement information back to the macro-payment layer, however, detailed micro-payment records are stored in the small transaction processor, where costs are lower.

To enforce the security controls, payment processing system 52 implements an auditing protocol based on the cryptographically secure selection module. Using this protocol, the macro-payment layer can examine small subsets of the detailed micro-transactions and reliably ensure that proper payment processing has occurred on all of the micro-transactions. This maintains security while providing a costs reduction.

Payment processing system 52 is designed for scalable, highly secure operation. The roles of principals and the operations that they conduct within the system have been carefully partitioned. In some arrangements, components are authenticated by a federated, public-key based authentication systems. Information that is designated to be kept confidential is encrypted when transmitted and stored, and information that needs to be authenticated is digitally signed. The system tightly controls credentials, limiting their use, and credentials may be revocable with a lightweight revocation process.

The cryptographically secure selection process provides a cost advantage by moving computations from a payment network center to the distributed small transactions processors (e.g., small transaction processors 54 and 56). Processing payments at the center of a payment system typically calls for a substantial centralized computing and communications infrastructure that may be rather expensive. Payment processing at small transaction processors may be carried out on commodity hardware that is substantially less expensive, and communication may be local to an ecommerce website. With the cryptographically secure selection module, payment processing system 52 provides a low-cost, scalable aggregation infrastructure that is capable of handling a large number of transactions at lower cost.

Typically, merchants manage their businesses at the micro-transaction level, as that is the level at which they interact with their customers. Payment processing system 52 attempts to optimize 3^{rd} party payment network interactions so that funds flow to the merchant in terms of batches of macro-level transactions. A settlement and reconciliation layer of the system maps the funds flows from the batch of macro-transactions to the individual micro-transactions. The settlement layer is capable of handling various factors including partial settlement, in which, for example, Visa has paid a subset of the settled transactions while American Express has withheld payment. Charge-backs are also handled, such as charge-backs when an issuing bank may initiate a charge-back process with the merchant related to a particular consumer's complaint. Another factor handled is the splitting of funds among a group of merchants both at the acquiring bank level and at the level of a small transaction processor.

Referring back to FIG. 4, small transaction processor 12 includes an audit and control module 62 to ensure that payment processing system 10 is in compliance with the rules associated with centralized payment processing systems run by the associations. The associations define compliance rules that may assume that nearly every payment is inspected by a trusted “Third Party Processor”. Some conventional systems may be capable of inspecting a relatively large percentage of macro-transactions, however, if the conventional system was needed to inspect a large percentage of micro-transactions, the cost of processing micro-transactions would be the same as the cost of processing macro-transactions, and merchants would be unable to enter small transaction markets.

Audit and control module 62 may provide a high level of confidence in micro-transaction processing compliance, without needing an auditing party to inspect every micro-transaction. Audit and control module 62 implements techniques of cryptographically secure selection as described in Patent Cooperation Treaty (PCT) application PCT/US02/12189, filed on Apr. 17, 2002 and herein incorporated by reference. A copy of the PCT application is provided in Appendix H. Cryptographically secure selection allows a subset of the micro-transactions to be audited in a manner that the auditor may reliably extrapolate results to the entire set. Audit and control module 62 provides the benefits of comprehensive compliance monitoring at a fraction of the cost, doing approximately 95% of the work at small transaction processor 12 and approximately 5% of the work elsewhere.

Various issues are checked by audit and control module 62. For example, the module may check if the settlement batch adds up to the claimed amount, if every claimed transaction was authorized, or are any duplicates present in the batch. Furthermore, audit and control module 62 may determine if there is the proper degree of AVS match, CVV match, of Verified-By-Visa match in each micro-transaction as requested by the interchange class. Other issues such as was the timing between auth, capture, and settlement within the bounds as designated by the interchange class may be checked. Audit and control module 62 is extensible and allows for other issues to be audited in the future.

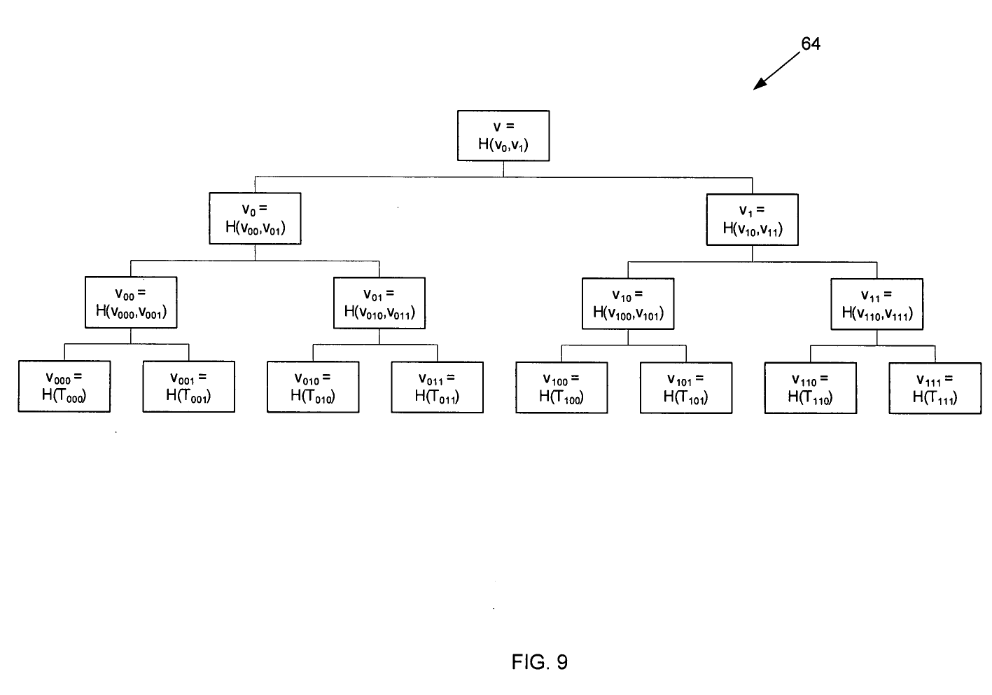

Referring to FIG. 9, the initial conditions for the audit are established when the merchant commits their transactions by signing them with a time-stamped public-key signature. Public-key signatures are computationally expensive. The technique of Merkle Trees replaces a batch of N public-key signatures and N secure one-way hashes with 1 public-key signature, 2*N-1 hashes, and HashSize*1 gN bytes more per message.

Referring to the figure, in this example a Merkle tree 64 (in which N=8) is shown that demonstrates a transaction that is digitally signed by a merchant. For example T₀₁₀ and SIGₘ(T₀₁₀) is equivalent to the same transaction T₀₁₀ and digital signature of the root of the Merkle tree SIGₘ(v) together with the chain of sibling hash values in the Merkle tree v₀₁₁,v₀₀,v₁,v. The recipient can check SIGₘ(v) and that v=H(H(H(v₀₀,H(T₀₁₀),v₀₀₁)),v₁), which proves that the merchant could have produced the digital signature SIGₘ(T₀₁₀)—i.e., if they could have produced the Merkle tree signature, they could have also directly signed a particular transaction such as T₀₁₀. The Merkle tree technique shares one signature SIGₘ(v) across all of N items in the tree, and since cryptographically secure hashes H are substantially cheaper to compute than public-key signatures, the computational cost is reduced by roughly a factor of N.

The Merkle tree technique typically calls for batch processing of signatures in batches of size N. Payment processing system 10 provides batching micro-transactions as part of its aggregation and settlement methodologies, so the technique applies naturally in those contexts without changing application behavior. The signature of each micro-transaction in the Merkle tree may be checked individually, without fetching the other elements of the tree. The technique substantially reduces the number of public-key signatures but maintains approximately all of the trust-scalability advantages of asymmetric cryptography.

Beginning at small transaction processor 12, at the time of capture of a micro-transaction T the small transaction processor generates a random bit-string R of length n with each bit uniformly drawn from {0,1}. Small transaction processor 12 adds the pair (T,R) to a Merkle tree computing a Merkle tree leaf signature Hⱼ(T,R). Periodically, the merchant's micro-transactions at small transaction processor 12 are settled, time-stamped with a settlement timestamp S that is generated by consumer account processor 16 and merchant account processor 18, and then a full Merkle tree is generated and committed by signing the root of the Merkle tree with the public key signature of the merchant. The top-level Merkle tree signature SIGₘ(v) is sent to consumer account processor 16 and merchant account processor 18 along with the settlement totals. This signature commits each of the micro-transactions in the batch and substantially “locks” them for future audits.

Subsequent audits by consumer account processor 16 or merchant account processor 18 may include either processor sending a request to small transaction processor 12 to return answers to an audit question (e.g., what are the total amounts of Visa-card transactions on a specified day?). Along with the request, consumer account processor 16 and/or merchant account processor 18 may specify the fraction of the micro-transaction audit set that should be returned by small transaction processor 12 as proof of the validity of the small transaction processor computed result. Consumer account processor 16 and/or merchant account processor 18 may specify this set by supplying a list of pairs of selection criteria (mask, match) that will be applied to the random bit-strings R associated with each transaction. The selection criteria mask and match are bit strings of length n, a micro-transaction will be returned if the bit-level “AND” of R with mask is equal to match for any of the criteria in the list. This mechanism allows for the selection of a fraction p of audited micro-transactions that support the truth of the audit, where p may be arbitrarily closely approximated by selecting a sequence of mask's with numbers of 1-bits corresponding to the 1's in p's representation as a binary fraction.

Small transaction processor 12 may execute the audit request and return the precise answer to the audit question by examining each micro-transaction at the processor, e.g. the sum of the Visa-card transactions on the specified day. Along with the answer, small transaction processor 12 may return the subset of the micro-transactions that match the selection criteria, this subset may serve as proof for the answer that the small transaction processor supplies.

Consumer account processor 16 and/or merchant account processor 18 verifies small transaction processor 12 results by (a) verifying the Merkle signatures on the returned micro-transactions to ensure that these transactions are the same as those that have been previously submitted to payment processing system 10 and (b) stepping-up the results in the audited set by a factor of 1/p, and testing to see if these results are close to the precise results returned by small transaction processor 20. If the stepped-up audit results are judged to be not approximately close enough, then consumer account processor 16 and/or merchant account processor 18 may repeat the audit, sending down the same request with new selection criteria. This process may be repeated until consumer account processor 16 and/or merchant account processor 18 are satisfied, or decides that small transaction processor 12 must be audited completely. For honest merchants, statistics may ensure that consumer account processor 16 and/or merchant account processor 18 may be satisfied with a partial audit within a reasonable amount of the time.

Payment processing system 10 is designed for scalable, highly secure operation. The roles of principals and the operations that they conduct within the system may be carefully partitioned. Trust Federation components are a distributed certifying authority for payment processing system 10. It uses public-key or other technology to authenticate each of the components of the system in its assigned role within payment processing system 10. Components are authenticated by a federated, public-key based authentication system. Typically, information that needs to be kept confidential is encrypted when transmitted and stored. Correspondingly, information that needs to be authenticated across administrative boundaries is digitally signed and auditable. Payment processing system 10 controls credentials, limiting their use, and all credentials are typically revocable with a lightweight revocation process.

Typically, payment processing system 10 does not store account numbers, CVV code, Track-1, or Track-2 data in small transaction processor 12, consumer account processor 16, or merchant account processor 18. Rather, one-way hashes of the account number are stored in databases. The one-way hashes are also used as the basis for transaction aggregation. In payment processing system 10, account numbers may be used in near real-time during an AUTH transaction (or during the AUTH phase of a SALE transaction). If the AUTH succeeds, then the account number is not required for further macro-payment system interactions—subsequent captures, credits, or voids use a REFID returned with the AUTH to specify the particular AUTH to which they apply. If the AUTH fails for any reason, then the system's AUTH protocol will require a caller to provide the account number again to attempt a new AUTH.

The servers in payment processing system 10 typically do not store the account number, CVV code, Track-1, or Track-2 data in storage. Additionally, this data is typically not written to a database, nor written out in clear text to any server log file. In some arrangements, payment processing system 10 aggregates transactions by matching transactions against a cryptographically secure 1-way hash function of the account number and expiration date. The methodology for computing the hash may implement such functions as a SHA-1 cryptographically secure message digest function.

For merchant customer service purposes, payment processing system 10 may retain the last 4 digits of the account number in clear-text. Customer service reps may view the last 4 digits, and search for transactions that match those digits and other transaction characteristics. Payment processing system 10 also allows a merchant customer service representative to search for transactions by an exact match of a credit card number. Internally, such a database lookup is based on the 1-way hash of the account number since the account number is typically not stored and may not feasibly be recovered from the 1-way hash.

Macro payment processor 24 in payment processing system 10 adapts the small payment processing service to 3^{rd} party payment processors via MPP plug-ins. When a 3^{rd} party payment processor supports an AUTH and CAPT process by which account numbers are presented only at AUTH time, then the MPP plug-in works just as small transaction processor 12 and consumer account processor 16. In particular, account numbers are securely passed to the payment processor during the AUTH, and are typically not retained in storage. However, some 3^{rd} party payment processors need an account number to be presented at each CAPT interaction. To support such processors, the MPP plug-in for the processor encrypts the account number and expiration date at AUTH time and re-presents the decrypted card number and expiration date at capture or credit time.

In some arrangements, encryption and key management are implemented using a hardware security module, such as the n-Cipher n-Shield. The system may also use a strong cipher such as AES-128. Encrypted card numbers are typically retained only for the period of time, which may be defined as a window between an AUTH and CAPT. Current credit card rules define this window to be approximately 7 to 30 days. After that period, payment processing system 10 deletes the encrypted account information. Keys are managed using a secure facility, such as the secure facilities provided by the hardware security module. The HSM provides for multi-layer security and a secure key management process.

Typically, small payments occur in relatively high volumes at relatively low price points. Payment processing system 10 is highly scalable and may be scaled to include thousands of highly distributed small transaction processors, consumer account processors, merchant account processors, macro payment processors, issuing bank servers, acquiring bank servers, etc. Payment processing system 10 may also be scaled for >1000× scalability, which may be incrementally scaled. For example, a 10-20× scale factor may be implemented prior to scaling the system for larger scale factors (e.g., 100-200×, 1000-2000×, etc.).

Through scaling, payment processing system 10 is capable of transparently partitioning the transaction processing process across thousands of distributed servers. This partitioning may take place at multiple levels. For example, functional partitioning, in which payment processing system 10 is designed to separate different aspects of transaction processing so that they may be securely and efficiently executed on separate servers. Micro-transaction processing may be separated from the processing of aggregated macro-transactions. Similarly, micro-transaction reporting may be separated from macro-transaction reporting. System functions that require long-term access to cardholder data that need to be encrypted may be separated from functions that do not require that access. The architecture may separate secure authentication of consumers for customer service purposes from the micro-transaction records that contain customer service data.

For organizational boundary partitioning, the architecture of payment processing system 10 takes into account the boundaries between distinct organizations that make up a payment ecosystem. These organizations include merchants (who may have multiple locations), acquiring banks, processors of acquiring banks, issuing banks, processors for issuing banks, and the associations that want their respective transactions kept private from one another.

For load partitioning, one consumer's transactions are typically independent of another consumer's transactions, and for many purposes the transactions of a particular payment instrument are independent of another. Individual payment instruments tend to have relatively few transactions, and so the demands for real-time processing of an individual consumer's transactions are not substantial and there is a great deal of potential parallelism among the transactions of different consumers. Merchants typically need an integrated view of the transactions associated with their business, and this may represent a significant volume of transactions. Merchants typically desire timely and fast information about their business, but there tends to be a limited requirement for hard real-time information.

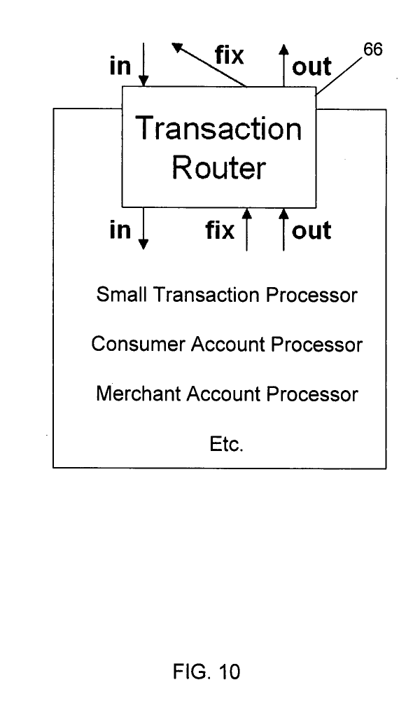

Referring to FIG. 10, in some arrangements, a component that implements load partitioning is a distributed transaction router 66. Typically most functional modules (e.g. small transaction processors, consumer account processors, merchant account processors, etc.) in payment processing system 10 includes one or more built-in router components. The router examines all incoming and outgoing message traffic.

Router 66 performs various message operations such as a fast inspection of XML messages, determining which node should process a request, etc. In one example, AUTH messages are partitioned by payment card number and merchant. After finding a card number and merchant identifier in the Auth, router 66 examines an associated routing table to find the particular server that may appropriately handle this request. In another example, a CAPT message is partitioned by a RefID that was returned at the time of the matching AUTH. A routing table is then used to map RefIDs to the proper server.

There are circumstances where additional application-level analysis of a message may reveal that a transaction should be handled at another location. In that case, the transaction may be re-routed, and router 66 determines a new route. In some arrangements routing is adaptive such that transactions may be properly routed a majority of the time (e.g., 99% proper routing ratio).

Router 66 may also be fault-tolerant and may handle nodes leaving and entering the routing set. Router 66 may manage warm spare nodes, and potentially may replace a failed node with another node within a relatively short period of time (e.g., a second or two).

Router 66 also handles geographic and functional partitioning by managing a set of domain names that are associated with particular services. By managing the domain names, router 66 may mitigate traffic among larger sets of IP addresses that map to those domain names.

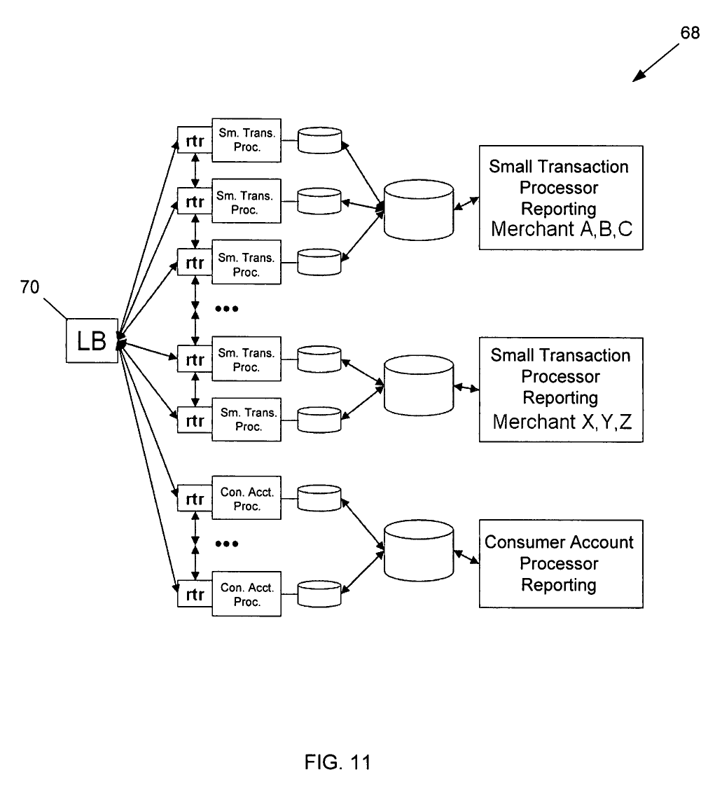

Referring to FIG. 11, one exemplary load partitioned processing node 68 is shown that includes a load balancer (LB) 70. In this arrangement, load balancer 70 is a conventional HTTP/SSL Load Balancer that provides “dumb” HTTP load balancing. In this arrangement, nodes including small transaction processors or consumer account processors are connected via transaction routers and perform application level routing. Individual small transaction processor or consumer account processor databases may be partitioned initially by payment card number, merchant account identifier, and/or merchant reference identifier, depending upon the particular engine transaction.

Small transaction processors and/or consumer account processor reporting and customer-self-service nodes typically execute from a common database that is accessed in nearly real-time. The small transaction processor and consumer account processor reporting load may be partitioned by payment card number and /or merchant. Although this reporting may be assigned a lower priority.

In general, organizations that implement payment processing system 10 typically assign their employees specific roles in the system. For example, an administration may be responsible for all operations in a store (or other business establishment), but mainly used to manage users. Typically, there may be only one of these users per store. A customer service department may include may include users who are the people that deal with requests and complaints about the merchants service. They may initiate and resolve customer service disputes in a designated database(s). A finance department may include users that keep track of store accounts, and may modify and track transactions, settlements, and payments. This user may also reconcile a payment record with the store's bank account.

Along with individual people, specific processes (implemented in software, hardware, or a combination of software and hardware) may also be assigned by the organization to perform particular operations. For example, a transaction API may be implemented to send transaction request documents to a small payment gateway. In each request XAL document there may be credentials that specify which merchant SDK client is the source of the transactions.

Another assignable process is a query API that may be implemented to send data queries to the small payment gateway database. Typically, the query API interface is used to integrate merchant business systems with the payment processing system. Each XML request from this assignable process specifies a particular merchant application. Still another assignable process is a management API that may be implemented to send server configuration and merchant application management documents to the small payment gateway. Each XML request from this assignable process may specify a particular merchant application and an operation to be performed on the merchant application such as reconciliation of payments or adjusting of aggregation settings.

To interact with the system, user interfaces are provided. These user interfaces interactively assist with transaction functions such as presenting summary reports, browsing transaction detail, and query transactions. The user interfaces also assist with settlement functions such as settlement summary reports, query settlements, and browsing settlement detail. Functions associated with payments are also assisted with one or more user interfaces. For example, operations associated with payment summary reports, querying payments, browsing payment details, and reconciling payments may be provided.

User interfaces may also assist in providing customer service messages such as customer service summary reports, dispute/service message workflow, or assisting in browsing dispute/service message sets or querying dispute/service messages. Account management operations may also be assisted, producing account reports, producing and managing new account types, querying active accounts, and browsing account details. Basic user house-keeping may also be provided with a user interface. For example, user account login functions, user account profile management functions, user sub-account management functions, audit user activities, etc.

Typically, a query API gives a merchant programmatic access to the same information available through the user interfaces. The merchant and FSI interfaces implement data queries and system management through a flexible interaction framework. This framework enables system access to common query and management code via multiple methodologies, including web browsers and a programmatic XML over HTTP API.

In general, these APIs may include business logic components that are comprised of query and data management implementations. The APIs may also include utility components that structure the workflow, and data access interfaces that enable database access (e.g., Object-Oriented data access and Relational Database Management Systems access) and database portability.

Operating a profitable business on a low-priced transaction stream puts significant pressure on many aspects of business operations. For example, customer service interactions may cost $5-$10 per incident, and in many businesses the overall customer service burden can average $0.50 or more per transaction. Payment processing system 10 implements a small transaction processor-based consumer self-service that reduces cost. Additionally, payment processing system 10 presents an online bill that details each purchase at the merchant's store. Online self-service improves customer satisfaction and lowers customer service costs through integrated bill presentment and dispute resolution.

Each micro-transaction within the bill may, under merchant control, include an automated dispute resolution software wizard that is capable of solving certain problems (e.g., re-downloading a song that has been purchased but accidentally deleted). The wizard may also collect information related to other problems and forward the information to merchant customer service personnel for resolution. Additionally, the wizard may resolve problems by issuing a credit, via policies under merchant control and with policies that may vary depending on the consumer's prior history with disputing transactions.

In some arrangements, payment processing system 10 may implement interfaces for the consumer to interface with one or more consumer account processors and small transaction processors. The interfaces associated with a small transaction processor may allow consumers to view transaction records, to initiate and resolve disputes, and to manage and produce financial instrument accounts that have been defined by a merchant.

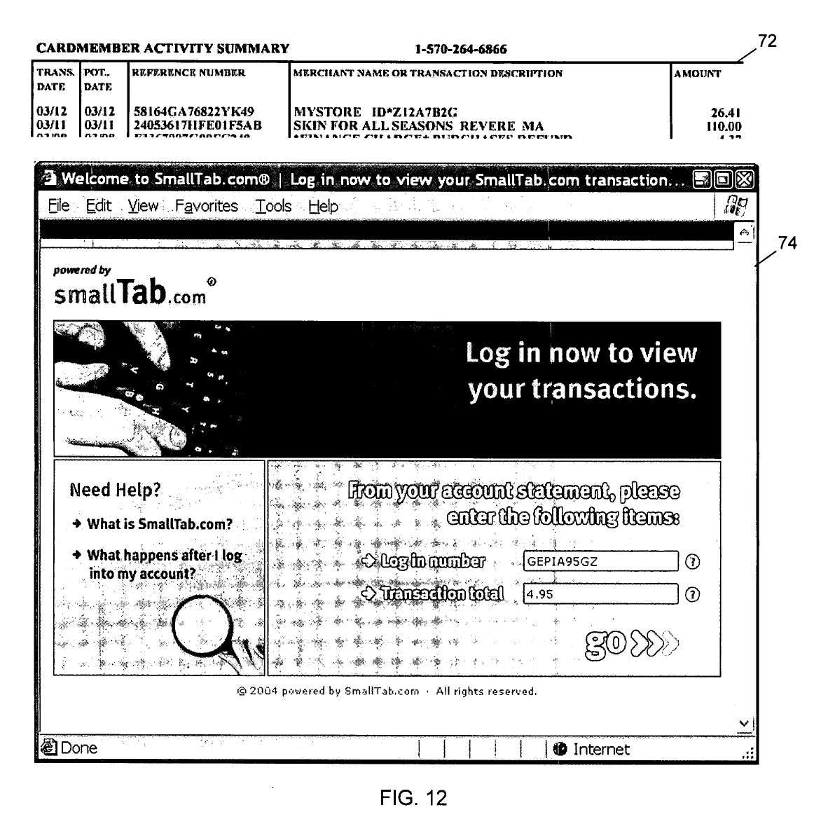

Referring to FIG. 12, payment processing system 10 may implement various methodologies for providing security to a web-based customer self-service. For example, a secure login may be provided by requiring information on a printed credit card statement to be used to gain access. In another secure implementation, login may be controlled by a web-based application associated with a merchant.

For example, to login with information on a printed statement 72, a consumer looks at his or her credit card statement. Next to the merchant's name on a charge line-item, an eight or nine character string identifier is provided. In this example, the string “Z12A7B2G” is included in a $26.41 charge from “MYSTORE”. This string may be used by the credit card user to log into a graphical user interface (GUI) 74. In particular, to identify themselves to the web-based interface, this character string is entered into a field labeled “Log in number”. Additionally, a transaction amount is entered into a field labeled “Transaction total”. In this example, the charge of $26.41 would be entered into the “Transaction total” and a graphical button labeled “go” would then be selected.

In a similar manner, a graphical user interface associated with a consumer account processor may allow consumers to access associated information. Similar to GUI 74, a consumer may be securely identified using information from a printed statement. In addition to a character string and a transaction total from the printed statement, other information may be used to gain access. For example, a transaction date, the last four digits of the consumer's credit card number, or other similar types of information may be used for securely providing access.

A consumer may gain access through various portals. For example, a consumer may gain access through his or her own computer system (or other digital device such as a cellular phone, personal digital assistant (PDA), etc.). Alternatively, a customer may also login through a merchant's system.

In some situations the merchant may have already authenticated the consumer, and would like to give the consumer access to the micro-transaction billing records without requiring further authentication. Payment processing system 10 supports this access via an API that creates a limited-time bill presentment credential that the merchant can pass to the consumer. This credential is a “Charges URL”, and may be valid for a specified amount of time for showing the consumer their micro-transaction billing activity. Accessing the Charges URL (either by a consumer selection or by a merchant-forced browser redirect) may present the consumer with their specified charges without requiring further authentication by the consumer.

Typically, the Charges URL is valid for a limited time (typically 30 minutes or less). If the Charges URL has expired, but the consumer's authentication with the merchant has not expired, then there may be a mechanism that may refresh the Charges URL by asking the merchant systems to give the consumer additional time. If the consumer is no longer authenticated with the merchant, the consumer may re-login and attain a new Charges URL.

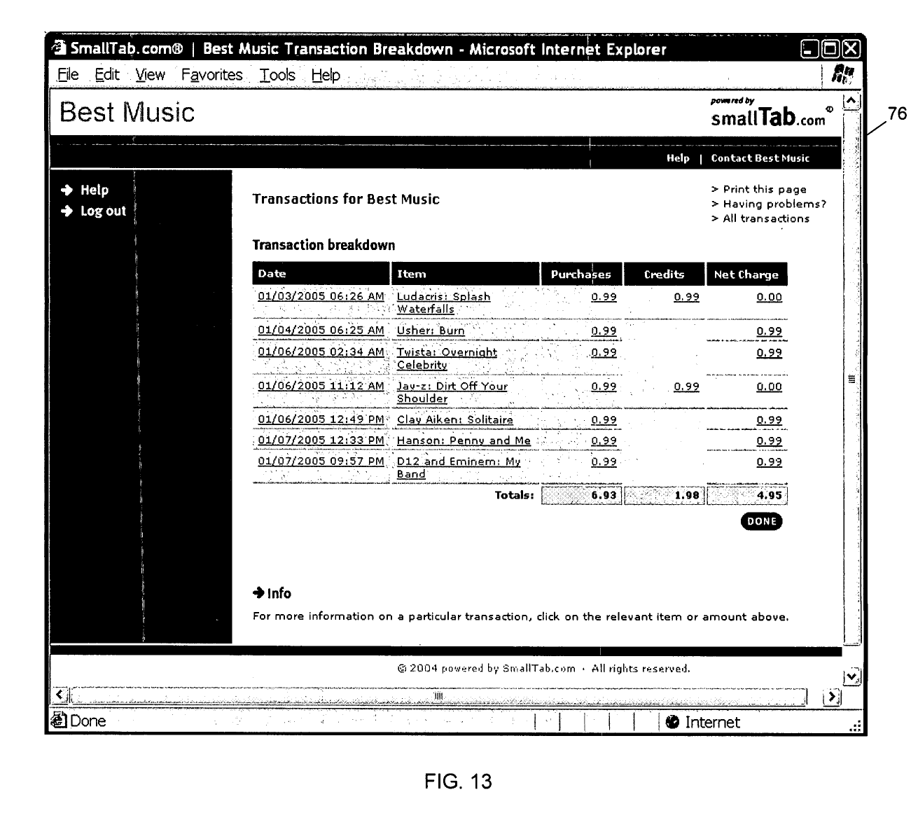

Referring to FIG. 13, upon gaining access, the consumer may be presented a GUI 76 that contains a list of the micro-transactions that have been aggregated into a macro-transaction. Each micro-transaction is user-selectable for gaining additional information.

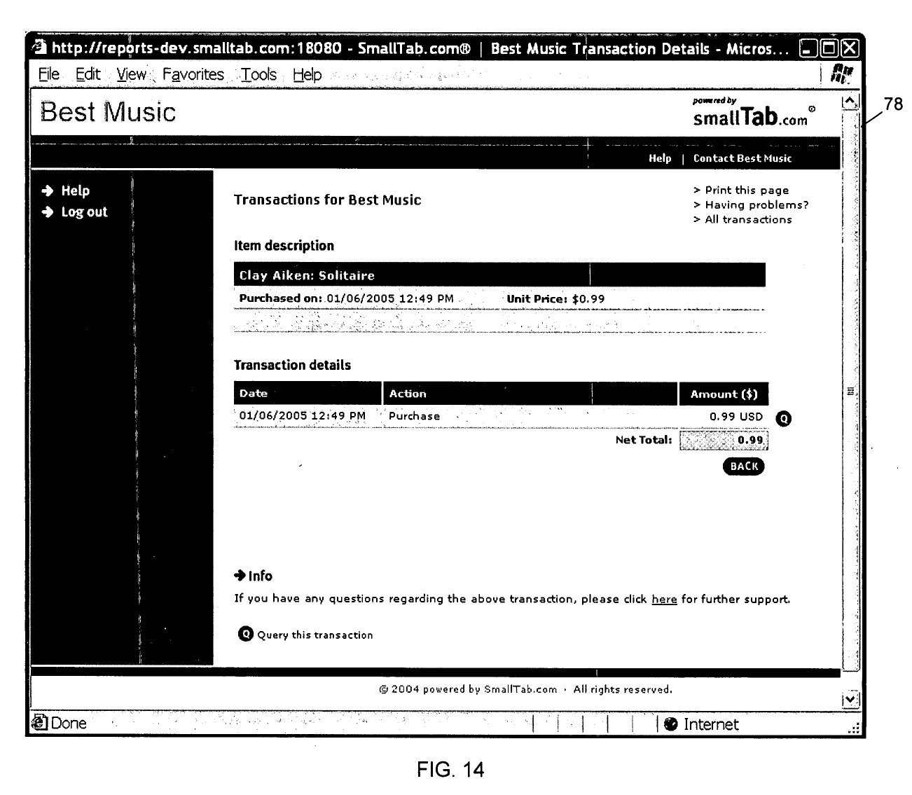

Referring to FIG. 14, exemplary GUI 78 presents additional information associated with a micro-transaction that was selected from a line item included in GUI 76.

Each micro-transaction within the bill may, under merchant control, include an automated dispute resolution wizard that may solve certain user related problems (e.g., re-downloading a song that has been purchased but accidentally deleted). The wizard may also collect information related to other issues and forward the information to merchant customer service personnel for resolution. Additionally, the wizard may resolve problems by issuing a credit to a consumer. Policies for resolving problems may be controlled by the merchant, and may be driven by anti-fraud technology included in payment processing system 10.

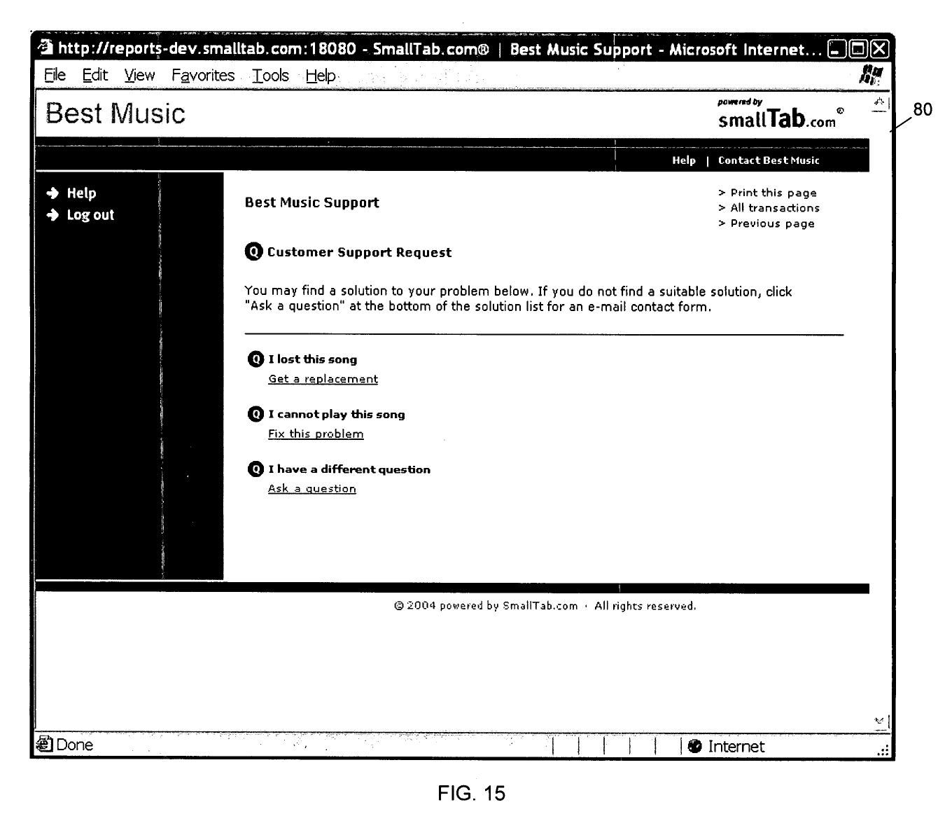

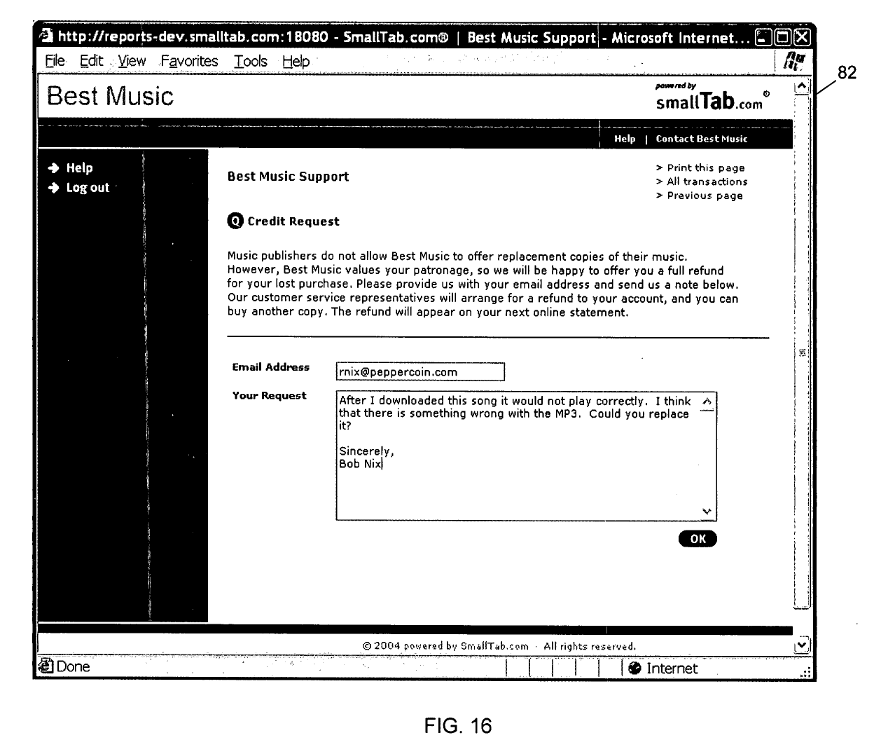

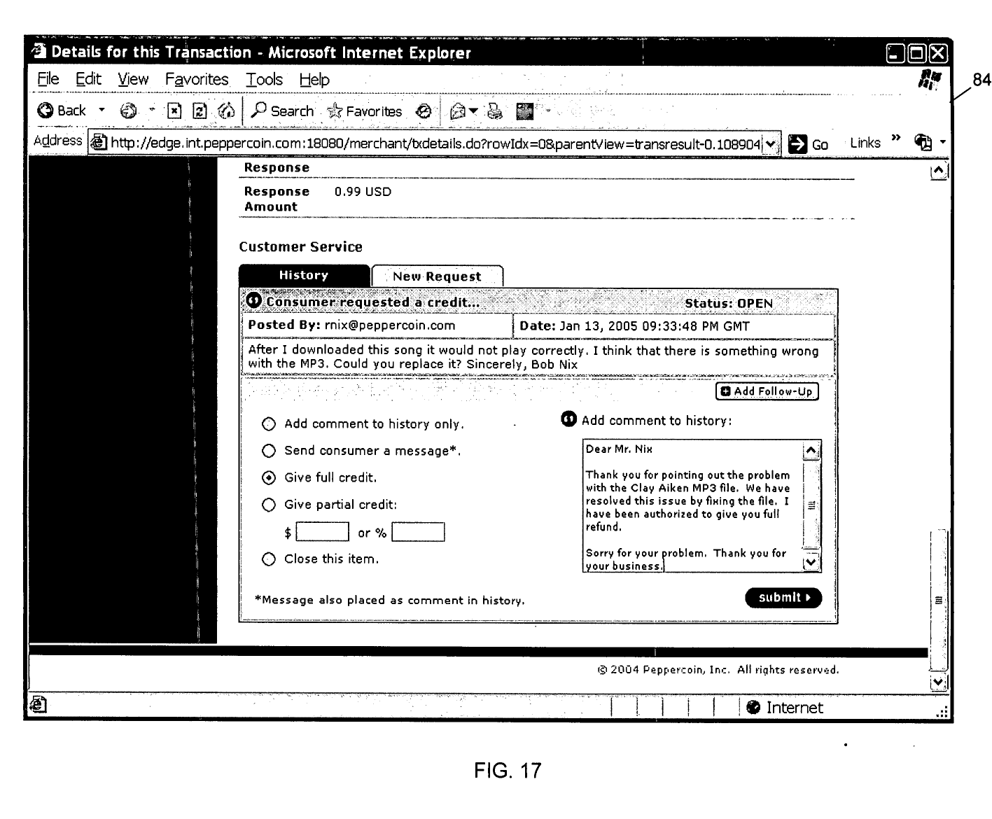

Referring to FIG. 15-17, a series of GUIs 80, 82, and 84 illustrate some typical user interactions. Referring to FIG. 15, the consumer has selected a “Customer Support Request” link and is presented a list of potential requests in GUI 80 as defined by a merchant. Referring to FIG. 16, in this example, by selecting an “I lost this song” link, GUI 82 is presented that enables the user to send in a customer support request for a replacement. Referring to FIG. 17, a customer support person (possibly associated with a merchant) is presented a request via GUI 84 that is associated with the problem identified via GUI 82. The customer support person may resolve the problem associated with the request. Upon resolution, an email may be sent to the consumer. Additionally, the consumer's online bill may be updated.

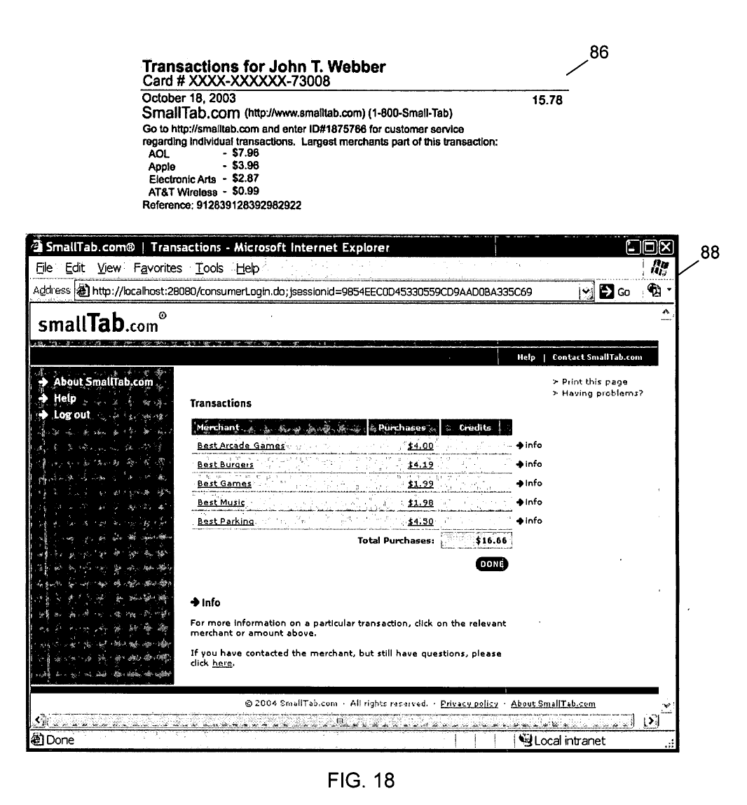

Referring to FIG. 18, if transactions are aggregated for a single merchant, the micro-transactions within a corresponding macro-transaction are associated with the same merchant. Those transactions may be billed under that merchant's name. As mentioned above, micro-transactions may be aggregated across a group of merchants. So, micro-transactions between a consumer and multiple merchants may be aggregated. Additionally, multiple micro-transactions transacted between a single merchant and a consumer may be aggregated. By aggregating these multiple micro-transactions, the consumer may be presented aggregated transactions associated with different merchants. For example, as shown in a printed statement 86, via a 3^{rd} party, such as “SmallTab.com”, or “Bank Small Payment Service”, multiple merchants may be ranked based on the aggregate of micro-transactions associated with a consumer.

Along with providing the aggregate data across multiple merchants, statement 86 also includes an identification number that may be used to access a 3^{rd} party website. For example, by accessing a website (e.g., http://smalltab.com) and entering in the identification number (e.g., 1875766), a customer service GUI 88 may be presented. In this example, GUI 88 presents a list of multiple merchants that are included in statement 86 and their corresponding subtotals. By selecting a particular link associated with one of the merchants, a list of individual transactions associated with that merchant are presented.

A number of implementations have been described. Nevertheless, it will be understood that various modifications may be made. Accordingly, other implementations are within the scope of the following claims.

### Appendices

APPENDIX A
Account Information.

| Information | Description |
|---|---|
| Account ID | Unique ID for this account |
| Instrument | Payment instrument associated with this account. |
| Merchant | Merchant associated with this account, if this is not a |
| | “universal aggregation” account. |
| Account type | Identifies how operations are to be done for this |
| | account (see Handlers, below). |
| Account data | Extension data for the account used by Small |
| | Transaction Suite plug-ins. |
| Ppcn data | Internal extension data associated with the account. |
| Status | Status of the account: PENDING, ACTIVE, |
| | EXPIRED, DISABLED or SUSPENDED. |
| Open auths | Set of AUTHs that have been granted against the |
| | balance but not yet captured. |
| Auth Balance | Running balance of open authed amounts on this |
| | account. |
| Last Transaction | Date of last transaction in the account |
| Transactions | Payment transactions within this account. |
| Account Events | Non-payment transactions within the account. |

APPENDIX B
Purchase Requests

| | |
|---|---|
| AUTH | Request authorization for potential purchase |
| CAPTURE | Confirm actual purchase based on an existing AUTH |
| SALE | Combined AUTH and CAPTURE |
| VOID | Reverse a recent CAPTURE, and show neither transaction |
| | on the customer's bill |
| CREDIT | Reverse an earlier CAPTURE, with both transactions |
| | showing separately on the customer's bill. |
| INQU | Inquire as to the status of an earlier request to this account. |

APPENDIX C
Pay-per-use additional requests

| | |
|---|---|
| SETSTATUS | Change status of a Pay-Per-Use account among |
| | Enabled, Disabled, Valid, Pending |
| TRANSFER | Transfer an existing Pay-Per-Use account to a |
| | different credit card (needed, for example, |
| | if an underlying card is stolen or has expired) |

APPENDIX D
Subscription additional requests

| | |
|---|---|
| CREATE | Create a new subscription & fund it with a |
| | cross-charge to the underlying credit |
| | account |
| CANCEL | Cancel an incomplete subscription, and refund |
| | (CREDIT) any unearned balance back to the |
| | underlying credit account |
| RENEW | Extend an existing subscription period. For |
| | pre-paid (one time charge) subscriptions, |
| | immediately create a cross-charge to the |
| | underlying account |
| ADJUST | Adjust the period of a subscription without |
| | creating any cross-charges |
| SETSTATUS | Change status of a Subscription account |
| | among Enabled, Disabled, Valid, Pending |
| TRANSFER | Transfer an existing subscription to a different |
| | credit card (needed, for example, if an |
| | underlying card is stolen or has expired) |

APPENDIX E
Post-paid additional requests

| | |
|---|---|
| CREATE | Create a new post-paid account. |
| BILL | Bill the post-paid charges on this account to the bill-to |
| | payment instrument. |
| ADJUST | Adjust the terms of the post-paid account, including for |
| | example changing the bill-to payment instrument. |
| SETSTATUS | Change status of an account among Enabled, Disabled, |
| | Valid, Pending |
| TRANSFER | Transfer an existing post-paid account to a different |
| | account. |

APPENDIX F
API arguments

| Element | Description |
|---|---|
| ACCT | Credit/debit card account number |
| ACCTCLASS | Class of account: Pay-Per-Use (default), PrePaid, Subscription, PostPaid |
| ACCTDATA | Container for Merchant-specific account data. This data is stored by the Peppercoin system and is made |
| | available to both client programs and server-side extensions |
| ACCTENDDATE | Date after which an account will no longer be valid (unless it is extended) |
| ACCTID | Internal ID of this account; returned by account inquiry, and used in subsequent requests |
| ACCTINFO | Element grouping information about an account; a query response can contain any number of ACCTINFO |
| | elements. |
| ACCTSTARTDATE | Date on which the account becomes valid. |
| ACCTSTATUS | Status of an account; in V3 must be one of ACTV, PNDG, EXPD, DISA |
| ACCTTYPE | Type of account. Account types may be defined dynamically through the API |
| ACCTTYPELABEL | Label for account type - potentially presented to the user. |
| AMT | Amount |
| AMTDUE | For pay-per-use accounts, the amount auth'd and pending capture. |
| AUTHBALANCE | For pre-pay and limited subscription accounts, the amount of resource auth'd but not yet captured. |
| AUTHEXP | The expiration date/time for an authorization |
| AVSRESP | AVS address response, for advice only |
| BALANCE | For pre-pay and limited subscription accounts, the amount of resources (in whatever units are defined) |
| | available for capture. |
| CHARGE | Compound element defining the behavior of the payment stream. |
| CITY | Cardholder's city. |
| COMMENT1 | User-defined value for reporting purposes only |
| COMMENT2 | User-defined value for reporting purposes only |
| COUNTRY | Cardholder's 3 letter country code. |
| CURRENCY | Currency of the amount |
| CVV | 3- or 4-digit CVV/CVC code from front/back of credit card |
| CVVRESP | CVV response, for advice only |
| DEBIT | Flag (empty element) used to indicate a balance adjustment is meant to be a debit instead of the default |
| | credit. |
| DEPOSIT | Compound element defining the behavior of the resource stream being subscribed to. |
| DESCRIPTION | Description of item in order |
| EDGEID | ID of the Edge that submitted this AUTH |
| EMAIL | Cardholder's email address |
| EXPDATE | Expiration date from credit card |
| GATEWAYRESPONSE | Optional, processor-specific, data to describe an AUTH failure in more detail. |
| IMAGE | Internet-accessible URL for item in order |
| INQURESPONSE | XML Object containing RESPONSE object of the transaction that is the subject of inquiry |
| MACCT | Merchant's account name with PPCN. |
| NAME | Name of item in order |
| NAMEONCARD | Cardholder's name on card |
| OFFSET | Defines offset before the end of a subscription charge period, at which time an attempt will be made to |
| | capture an additional charge increment to fund the subscription |
| OPERATOR | Identification field that external app-s can use to identify who submitted this transaction. |
| ORDER | Top-level element for Order message |
| ORDERINFO | Contains information related to the thing purchased in an Order transaction |
| PERIOD | Period over which a subscription payment or resource allocation is renewed |
| POSMODE | Mode in which Point-of-Sale device is used |
| POSTAL | Cardholder's 5- to 9-digit postal code. |
| PPCNDATA | Container for account data defined by Peppercoin and supported by Peppercoin-supplied standard handlers |
| PRODUCTKEY | Product class |
| QUERYID | Merchant's ID for this request. If this is provided in an account inquiry (ACTQ), it will be returned in the |
| | response. |
| QUERY-PARAM | Empty element with optional Attribute RESPONSE which takes values “BRIEF” or “FULL”. If not present, |
| | response will be BRIEF. |
| REFID | Reference ID, used for Capture, Void, Inquiry Transactions and Credit Transactions. |
| REQUEST | Primary message sent from client; normally top-level, but may be contained in an ORDER |
| REQUESTID | Merchant's ID for this request. |
| RESPAMT | Amount of credit granted |
| RESPMSG | Message describing the response code given. |
| RESPONSE | Response to a request (or an ORDER?); normally top-level, but may be contained in an INQURESPONSE |
| RESULT | Primary response code, indicating success or failure |
| SERVERID | Identifying account for the Merchant's server that is the transaction source |
| SERVERKEY | Key/password for the Merchant's server that is the transaction source |
| STATE | Cardholder's state if in USA - two-letter code. |
| STATUS | Account status: one of {ACTIVE\|PENDING\|EXPIRED\|DISABLED} |
| STREET1 | Cardholder's street address (e.g. 12 Main St.) |
| STREET2 | Optional second line for cardholder's street address. |
| TRACK1 | Card swipe data from Track 1 |
| TRACK2 | Card swipe data from Track 2 |
| TRXTYPE | Transaction type; identifies the operation to be performed, and implicitly determines which other elements |
| | are valid and/or required |

APPENDIX G
Aggregation parameters

| INTELLIGENT AGGREGATION | |
|---|---|
| PARAMETER | PARAMETER DESCRIPTION |
| Business Model | Business Model of this particular Account: Pay-Per-Use, PrePaid, Subscription, Post-Paid |
| Payment Instruments Accepted | Payment instruments accepted by this business: Visa, MasterCard, American Express, |
| | Discover. |
| Visa and MasterCard Interchange | Informs the Intelligent Aggregation system of the merchant's fully qualified interchange |
| Classifications | classes for Visa and MasterCard transactions for this business. Intelligent Aggregation will |
| | automatically consider transaction-level issues in optimizing interchange qualification |
| | assuming that fully qualified transactions will be processed at the rates of the selected class. |
| | Intelligent Aggregation has no visibility into business-level interchange qualification issues; |
| | specifying the wrong class here will not affect the classification of macro-transactions, but it |
| | will cause incorrect optimization of aggregation. |
| Acquirer & Processor Fees for Visa | Total processing fees paid to acquirer and processor paid for non-aggregated transactions. |
| and MasterCard | These fees are in addition to the interchange fees for Visa and MasterCard. |
| American Express/Discover | Informs the Intelligent Aggregation system of the merchant's processing fees for American |
| Processing Fees | Express, Discover, and other non-interchange based systems. |
| Cost of Funds | The cost of funds on an annual basis. This quantity is used to estimate the financial impact, |
| | such as inventory costs, of extending the aggregation window. |
| Fraud Rate | The expected percentage of transactions that are anticipated to be fraudulent. |
| Customer Service Rate | The expected percentage of transactions that are anticipated to trigger customer service |
| | requests. |
| Authorization Amount Policy | Set the policy for calculating an authorization amount for each transaction. Options include: |
| | a fixed amount determined by the Merchant; a dynamic amount determined by the average |
| | buying behavior in the Merchants business or for the particular product class; a dynamic |
| | amount based on an analysis of the consumers buying behavior from this Merchant in the |
| | past; or a dynamic amount based on a coarse-grained analysis of this consumers buying |
| | behavior across other businesses in the past. Interchange classification considerations may |
| | limit the amount, as will overall maximums defined by the Merchant. |
| Authorization Maximum | Set the policy for calculating the length in days of the aggregation window for each |
| Window Length Policy | transaction. The calculation balances observed behavior against the interchange |
| | classification optimization considerations. Options to determine the window size include: a |
| | fixed length determined by the Merchant; a dynamic length determined by the average |
| | buying behavior in the Merchants business or for the particular product class; a dynamic |
| | length based on an analysis of the consumers buying behavior from this Merchant in the past; |
| | or a dynamic length based on a coarse-grained analysis of this consumers buying behavior |
| | across other businesses in the past. Interchange classification considerations specific to the |
| | consumer's payment instrument may change the calculation parameters, as will the overall |
| | maximums defined by the Merchant. |
| First-Time Consumer Policy | Set the policy for handling first-time consumers. Policies include: not aggregating first-time |
| | customers, or treating first time customers as low-activity, mid-activity, or high-activity |
| | consumers. |
| Aggregation Interchange Class | Control whether the aggregation policy is allowed to change transaction interchange |
| Policy | classification if the policy determines this would be most efficient. The savings through |
| | downgrade must exceed the threshold efficiency amount. Options include forcing |
| | aggregation to stay within the fully qualified interchange class, allowing a downgrade to a |
| | mid-qualified class, or allowing a downgrade to a non-qualified class. |
| Max Aggregated Transaction | Impose a cap on the maximum amount of an aggregated macro-transaction. |
| Amount | |
| Max Micro-Transaction Amount | Maximum amount of a micro-transaction within an aggregated macro-transaction. |
| | Transactions larger than this amount will not be aggregated. |
| Max Micro-Transaction Count | Maximum number of micro-transactions within an aggregated macro-transaction. |
| Max Aggregation Window Length | Maximum number of days of aggregation time. The actual aggregation time may be reduced |
| | by many factors including: the pace of consumer purchases; restrictions based on interchange |
| | qualification; dynamic cost/benefit analysis; and other factors. |
| Periodic Aggregation Window | Terminate aggregation on a periodic boundary, such as daily, on a particular day of the week |
| Termination | or day of the month. |
| Aggregation Opt-in/out | Allow the consumer to opt-in or opt-out for aggregation. Controls whether opt-in or opt-out |
| | is the default. |
| Payment Instrument Validation | Ensure that the consumer payment instrument is valid before aggregating. Payment |
| Policy | instruments are validated using an authorization for either the targeted capture amount or $1. |
| | This setting primarily affects the behavior of aggregation policies that do not require prior |
| | authorization. |
| Validation Lifetime | Lifetime in days of a prior payment instrument validation. If the system will not re-do |
| | validation if it has validation information that is fresher than this number of days. Note that |
| | this setting does not affect transaction authorization behavior. |
| AVS Policy | Control whether an AVS match is required on every transaction. |
| CVV Policy | Control whether a valid CVV code must be supplied with every transactions. |
| Maximum Micro-Transaction | Limit consumers to the specified number of transactions within the velocity check period. If |
| Velocity | this quantity is less than or equal to zero then velocity is not checked. |
| Velocity Check Period | Check transaction velocity within the specified period: daily, or hourly with a supplied offset. |
| Fraud Score Aggregation Cutoff | Transactions with fraud scores above this amount are not aggregated. |
| Customer Service Score | Transactions with customer service scores above this amount are not aggregated. |
| Aggregation Cutoff | |

### Appendix H

PCT application US02/12189

What is claimed is:

1. A payment processing system, comprising:
a first transaction processor configured to aggregate cost data associated with low-priced sales transactions between a consumer and a merchant, the first transaction processor is further configured to send data that represents the aggregated cost data to an acquiring banking entity associated with the merchant; and
a second transaction processor configured to store data that represents each individual low-priced sales transaction, wherein the stored data is accessible by at least one banking entity associated with the merchant.

2. The payment processing system of claim 1, wherein the second transaction processor is located remote from the consumer and the merchant.

3. The payment processing system of claim 1, wherein the first transaction processor is further configured to aggregate cost data associated with low-priced sales transactions between with the merchant and at least two consumers.

4. The payment processing system of claim 1, wherein the first transaction processor is further configured to aggregate cost data associated with low-priced sales transactions associated with at least two merchants, wherein the merchants are associated with the same banking entity.

5. The payment processing system of claim 1, wherein the consumer pays the merchant for the low-priced sales transactions on a pay-per-use basis.

6. The payment processing system of claim 1, wherein the consumer pays the merchant for the low-priced sales transactions on a pre-paid basis.

7. The payment processing system of claim 1, wherein the consumer pays the merchant for the low-priced sales transactions on a subscription basis.

8. The payment processing system of claim 1, wherein the consumer pays the merchant for the low-priced sales transactions on a post-paid basis.

9. The payment processing system of claim 1, wherein the stored data that represents each individual low-priced sales transaction is accessible by the acquiring banking entity.

10. The payment processing system of claim 1, wherein the stored data that represents each individual low-priced sales transaction is accessible by an issuing banking entity associated with the consumer.

11. The payment processing system of claim 1, wherein the stored data that represents each individual low-priced sales transaction is accessible by the consumer.

12. The payment processing system of claim 1, wherein the first transaction processor is further configured to direct a consumer request to the second transaction processor for providing customer service.

13. The payment processing system of claim 1, wherein the first transaction processor is located at an issuing banking entity associated with the consumer.

14. The payment processing system of claim 1, further comprising:
a third transaction processor configured to track reconciling of a payment with at least one of the low-priced sales transactions.

15. The payment processing system of claim 14, wherein the third transaction processor is located at an acquiring banking entity.

16. The payment processing system of claim 1, further comprising:
a fourth transaction processor configured to translate the aggregate cost data into a format for a third party.

17. The payment processing system of claim 16, wherein the fourth transaction processor is located in a server that includes the first transaction processor.

18. The payment processing system of claim 1, wherein the stored data that represents each individual low-priced sales transaction includes a one-way hash of an account number associated with at least one of the transactions.

19. The payment processing system of claim 1, wherein stored data is decrypted for access.

20. The payment processing system of claim 1, wherein at least one of the low-priced sales transactions occurs at a kiosk device.

21. The payment processing system of claim 1, further comprising:
a third transaction processor configured to aggregate cost data associated with low-priced sales transactions between the consumer and a second merchant.

22. The payment processing system of claim 1, wherein the merchant provides the consumer with preferential treatment to encourage future transactions with the merchant.

23. A method of processing payments, comprising:
receiving data that represents a first low-priced sales transaction between a first consumer and a first merchant;
aggregating the cost of the first low-priced sales transaction and the cost of a second low-priced sales transaction between the consumer and the merchant;
storing data associated with the first low-priced sales transaction such that the data is accessible by at least one banking entity associated with the merchant; and
sending data that represents the aggregate cost to an acquiring banking entity associated with the merchant.

24. The method of claim 23, further comprising:
aggregating the cost of a low-priced sales transaction associated with the first consumer and the cost of a low-priced sales transaction associated with a second consumer.

25. The method of claim 23, further comprising:
aggregating the cost of a low-priced transaction associated with the first merchant and the cost of a low-priced sales transaction associated with a second merchant, wherein the first and second merchants are associated with the acquiring banking entity.

26. The method of claim 23, wherein the stored data associated with the first low-priced sales transaction is accessible by the acquiring banking entity.

27. The method of claim 23, wherein the stored data associated with the first low-priced sales transaction is accessible by an issuing banking entity associated with the consumer.

28. The method of claim 23, wherein the stored data associated with the first low-priced sales transaction is accessible by the consumer.

29. The method of claim 21, wherein storing data associated with the first low-priced sales transaction includes applying a one-way hash to an account number associated with the first low-priced sales transaction.

30. A computer program product residing on a computer readable medium having a plurality of instructions stored thereon which, when executed by a processor, cause that processor to:
receive data that represents a first low-priced sales transaction between a first consumer and a first merchant;
aggregate the cost of the first low-priced sales transaction and the cost of a second low-priced sales transaction between the consumer and the merchant;
store data associated with the first low-priced sales transaction such that the data is accessible by at least one banking entity associated with the merchant; and
send data that represents the aggregate cost to an acquiring banking entity associated with the merchant.

31. The computer program product of claim 30, further comprising instructions to:
aggregate the cost of a low-priced sales transaction associated with the first consumer and the cost of a low-priced sales transaction associated with a second consumer.

32. The computer program product of claim 30, further comprising instructions to:
aggregate the cost of a low-priced transaction associated with the first merchant and the cost of a low-priced sales transaction associated with a second merchant, wherein the first and second merchants are associated with the acquiring banking entity.

33. The computer program product of claim 30, wherein the stored data associated with the first low-priced sales transaction is accessible by the acquiring banking entity.

34. The computer program product of claim 30, wherein the stored data associated with the first low-priced sales transaction is accessible by an issuing banking entity associated with the consumer.

35. The computer program product of claim 30, wherein the stored data associated with the first low-priced sales transaction is accessible by the consumer.

36. The computer program product of claim 30, wherein storing data associated with the first low-priced sales transaction includes applying a one-way hash to an account number associated with the first low-priced sales transaction.
